(19) United States
(12) Patent Application Publication
(10) Pub. No.: US 2002/0188527 A1
(43) Pub. Date: Dec. 12, 2002

(54) Management and control of online merchandising

(75) Inventors: Becket S. Dillard, Redmond, WA (US); Carl L. Highland, Bellevue, WA (US)

Correspondence Address: LAW OFFICES OF RONALD M. ANDERSON, 600 - 108th Avenue N.E., Suite 507, Bellevue, WA, 98004, US

(73) Assignee: AktiNet, Inc.

(21) Appl. No.: 10/155,907

(22) Filed: May 23, 2002

Related U.S. Application Data
(60) Provisional application No. 60/293,323, filed on May 23, 2001.

(51) Int. Cl. G06F 17/60

(52) U.S. Cl. 705/27

(57) ABSTRACT

The present invention is directed to a system and method for managing online merchandising. In one embodiment, a hierarchical management system enables managers to define an online merchandising offer, and to establish rules regarding the offer. The manager then authorizes an operator who develops the online offer content using the offer management system. The completed offer cannot be posted online until predefined checks ensure the offer content conforms to the manager defined rules. Preferably, the online content is inserted into a Web page using a dynamic node that links to the offer management system, enabling the manager to exert real-time control of the offer content. In another embodiment, an existing Web site is enabled to include such online offers, by inserting a plurality of dynamic nodes into the Web page, such that when not actively displaying offer content, the dynamic nodes are minimized in size and not apparent to a user.

### RELATED APPLICATIONS

This application is based on a prior copending provisional application Serial No. 60/293,323, filed on May 23, 2001, the benefit of the filing date of which is hereby claimed under 35 U.S.C. §119(e).

### FIELD OF THE INVENTION

This invention generally pertains to the online merchandising of goods and services over a networked environment, and more specifically, to the management of such online merchandising using a hierarchical structure, in which rights and duties are definable, based on hierarchical levels, and the display of such online merchandising content using dynamic nodes actively linked to an online management tool.

### BACKGROUND OF THE INVENTION

Originally intended as a communication network for information exchange between government agencies, researchers and academics, the Internet evolved into a worldwide commerce vehicle during the latter half of the 1990s. The Internet is a unique commerce vehicle. It enables the transfer of digital content, possesses strong interactive potential, has no geographical limitations, and is a self contained advertising medium capable of immediately delivering electronically distributed products or services. The Internet represents an opportunity for new and existing merchants to publish virtual catalogs, to create integral links to physical locations, or to create stand alone online shopping destinations. The Internet has no geographical limitations.

Barriers to entry for Internet commerce and marketing are relatively low, thanks to many Web site development tools which have become available. These tools enable thousands of diverse, startup merchants to develop Web sites in order to distribute products and services in direct competition with larger and more established competitors. Unlike shoppers at physical retail and wholesale locations, Web site visitors cannot always distinguish smaller merchants from multinational corporations. Sophisticated Web site design, development technology, and communication techniques and methods level the playing field between small and large competitors. Clearly, major sales and marketing opportunities exist in such an environment.

Unlike print and broadcast media, the Internet can totally engage users. With sophisticated programming, advertisers, sponsors, and merchants can target information directly to users based upon stealth electronic data gathering processes (e.g., data gathered with “cookies”), self-selected user criteria, shopping patterns, and geographic or demographic data. Users, conversely, can select when, or if, they want to receive or respond to informational or incentive alerts through their computer or other devices. Users can communicate their interests, request additional information, or make a purchase without leaving the comfort of their home or office. This convenience and interactivity provides marketers and merchandisers great opportunities to develop new customers. It also creates issues related to the merchants' ability to keep their Web site fresh, with new information, merchandising content, features, and products. However, coordinating special offers and business-critical occasions between offline and online marketing strategies is difficult, because the Internet is a highly complex and technical medium, often requiring highly skilled programmers to implement timely online updates of Web sites and the underlying support code.

As the Internet has evolved, the available programming tools and processes have not kept pace with the everyday needs of merchandisers. Development software is limited and cumbersome when applied to rapid content change and redeployment of immediate merchandising content. The same tools used to create the original Web site have been, out of necessity, utilized to create and maintain daily merchandising content.

While merchandisers desire the capability for rapid change in informational content, promotional offerings, and terms and conditions of sale, the process of implementing these changes is most often time consuming and labor intensive. For larger Internet merchants, teams of highly-trained programmers are often employed to write temporary or case-by-case code to support online merchandising efforts, a task with which highly-skilled programmers are not necessarily enamored or motivated to accomplish in the way that marketing people are.

Sites that do not meet commercial expectations are common, whether due to lack of funding, poor business models, or the inability to create and deploy up-to-date and compelling merchandising offers or content. Many Web sites have struggled with the maintenance processes that require extensive reliance upon programmers to: (1) translate the marketers' concepts and requirements into attractive and effective online displays, (2) write and test the code before implementation, and (3) manually deploy the content to one or more display pages and/or Web sites, or other wired or wireless access points.

To improve response time and to meet growing competition, the marketers' immediate answer is to either scale back their needs or to engage more programmers. The former solution imposes competitive disadvantages and may not meet consumer expectations, while the latter solution adds significant overhead expense.

Programmers sometimes respond to the needs of marketers/merchandisers by writing modifiable merchandising features into the backend of Web sites, allowing merchandising staff to execute updates using graphic drop-ins and implement basic HTML code on a self-serve basis. For many merchants this solution is sufficient. But for time-sensitive material, or material designed for broad distribution, richer online merchandising methodologies are required. Dozens of programmers clipping and pasting content into individual Web addresses, on a case-by-case basis, is cumbersome and ineffective.

As this need for more effective merchandising tools evolves, developers are creating shortcuts, integrated wizards, and merchandising plug-in tools that marketers can use to generally manage and update Web content. Most of these tools are delivered via disc, or download. However, these general content management tools are not focused specifically on incentive merchandising or rapid content distribution.

Other online approaches, as well as online/offline hybrids, have developed to provide means for merchants to electronically market and merchandise their products and services. Merchants can have their merchandising offers or discount coupons placed on the Web sites of direct mail coupon distributors, who scan and digitally transfer printed offers to their online sites. Merchants can purchase advertising, which may include incentives, through a variety of online services engaged in distributing the merchandising links to a disparate network of affiliate sites. Many merchants place offers to sell, barter, trade or auction items on their Web sites or auction platforms. These new marketing methodologies and channels are rapidly blurring competitive distinctions between merchants, as consumers are increasingly empowered to find the “best deal.” Online consumers need only click or search for other sites offering comparable merchandise to compare the offerings of competitors.

It would be desirable to provide tools to meet these challenges, by enabling merchants to rapidly create, post, and distribute timely incentive merchandising content across a logical network of organized Web sites and access points in near real-time using automated processes. Preferably, such tools should enable editing and updating functions to be handled directly by the marketers and merchandisers, with minimal intervention from skilled programmers.

It would further be desirable to provide tools to enable content to be distributed across networks and syndicates of merchants related to the sponsoring merchant, by business relationships, ranking, and priorities that are mapped into the logic of the system by the sponsoring merchant. Such a tool should enable incentive offer creation to be integrated with methods that enable Web site visitors to organize and find offers that interest them.

Preferably, such a tool should enable merchants to attract and keep users, by making it easier for them to shop online, or by driving offline foot traffic into a physical store of the merchant. The tool should enable users to group a merchant's incentive offers by company, category, or brand, select those products or services of greatest interest, store the offers for later retrieval, and/or redeem the product or service incentive offers by presenting an electronic version of the incentive offer via the Internet to the merchant's Web site, or download and print the incentive for redemption at a physical location.

Such a tool should also preferably include a reporting and analysis system into which all syndicated or distributed content is directly tied, enabling merchants using the tool to receive timely reports on merchandising content, grouped thematically or by other sponsor-defined methods. A preferred tool should enable a merchant to monitor the activity of incentive offers, and to control the distribution of incentive offers by geography, demographics, or by the quantity of incentive offers redeemed. Additionally, the tool should have the ability to readily edit, react, and respond to user feedback and behavior. These features should be integrated into a single application.

While the Internet originally was accessible only through computers, new technologies are directed at a set of Internet enabled (wireless or wired) access points, including pagers, cellular phones, handheld computers, household appliances, automobile dashboards, and digital signs. Accordingly, the tool should support the control and distribution of online merchandising content using computing devices having diverse form factors, including the newer such devices noted above.

### SUMMARY OF THE INVENTION

The present invention is directed to a method for hierarchically managing online offers available in a networked environment. In one preferred embodiment, a hierarchical management method is provided. The method is executed using an online offer management tool and includes the steps of defining an online offer, and then enabling at least one administrator to establish rules relating to the online offer. The administrator is further enabled to allow at least one other operator access to the offer management tool to generate the online offer content. Based on the rules established by the administrator, each offer is checked to determine if the generated online offer content is consistent with those rules, before posting the generated online offer to the networked environment.

The online offers can include, but are not limited to, an offer for the sale of goods, a redeemable coupon, a rebate, a contest, an incentive designed to induce a user to carry out a specific call-to-action, and an incentive designed to induce a user to make a specific call-to-purchase. Preferably, the rules include parameters defining the online offer, which can include a duration for which the online offer is to be available, a target audience to which the online offer is directed, an online location to which the online offer is to be posted, a specific good to which the online offer is directed, a specific service to which the online offer is directed, a dollar value associated with the online offer, a percentage associated with the online offer, and a size with which the online offer is to be displayed.

The administrator can enter the rules into the offer management tool. Alternatively, an administrator can authorize operators to enter the rules into the offer management tool. Each operator should ensure that the style of the online offer content is consistent with a style associated with an online location to which the online offer is to be posted.

In at least one embodiment, with respect to determining if the generated online offer content is consistent with the rules established by the at least one administrator, the offer management tool automatically distributes the generated online offer to individuals whose approval is required per the rules established by the administrator.

Preferably, the online offer is posted to the networked environment by inserting a dynamic node disposed at the online location to which the online offer is to be posted, such that the dynamic node is actively linked to the offer management tool.

The administrator and operator can be the same individual, although the method enables single administrators to manage multiple operators. In some embodiments, the least one administrator and the at least one operator are employed by the same entity, while in another embodiment, some of the operators can be employed by other entities. In one embodiment, the administrator is a retailer, and the operator is a manufacturer. In another embodiment, the administrator is a retailer, and the operator is a reseller, while in yet another embodiment, the administrator is a manufacturer, and the operator is a retailer.

Some embodiments further include the step of enabling the offer management tool to track activity related to the posted online offer. Such activity can include hits, redemptions, purchases, and requests for information.

With respect to enabling operators to generate online offer content, in at least one embodiment, the operators are enabled to use the offer management tool to define a location on a Web page where the online offer is to be displayed, and then to determine if a dynamic node exists at the defined location. If no dynamic node exists, each operator is enabled to use the offer management tool to insert a dynamic node at the defined location. Finally, each operator is enabled to use the offer management tool to define activation and deactivation parameters that control a display of an online offer at the defined location.

The activation and deactivation parameters can include rotatably displaying a plurality of different online offers at the defined location according to a defined schedule, displaying an online offer at the defined location according to a profile of a user accessing the Web page corresponding to the defined location, displaying an online offer at the defined location until a predefined number of hits has been achieved, and/or displaying an online offer at the defined location according to a predefined schedule. The activation and deactivation parameters can include minimizing a size of a dynamic node at the predefined location when no online offer is to be displayed, such that an empty frame is not displayed to a user viewing the Web page corresponding to the predefined location.

In addition to the aforementioned embodiments relating to the method for hierarchically managing online offers available in a networked environment, the present invention also relates to a system having elements that carry out functions generally consistent with the steps of the method described above. The system preferably includes a display electrically coupled to a processor. Also included is a memory in which a plurality of machine instructions defining an offer management tool application are stored. The processor is coupled to the display and to the memory to access the machine instructions. Execution of the machine instructions by the processor causes functions generally consistent with the steps discussed above to be carried out.

Still another aspect of the present invention is directed to an article of manufacture adapted for use with a processor and including a memory medium that stores a plurality of machine instructions. When the plurality of machine instructions are executed by a processor, they cause the processor to carry out functions generally consistent with the steps of the method described above.

Another aspect of the present invention is directed to a method for enabling an online offer to be displayed to a user in a networked environment by utilizing dynamic nodes linked to an offer management system. The method includes the steps of determining a specific location available in the networked environment where the online offer is to be displayed, inserting a dynamic node at the specific location, such that the dynamic node is linked to the offer management tool, using the offer management tool to generate an online offer, using the offer management tool to define activation and deactivation parameters that will control a display of the online offer at the specific location, and displaying the online offer at the specific location according to the defined activation and deactivation parameters. The method also includes the step of using the offer management tool to track activity relating to the online offer. Such activity can include hits, redemptions, purchases, and requests for information. The online offer can be an offer for the sale of goods, a redeemable coupon, a rebate, a contest, an incentive designed to induce a user to a specific call-to-action, or an incentive designed to induce a user to a specific call-to-purchase.

In at least one embodiment, the method includes the step of using the offer management tool to control access to the dynamic node, such that only authorized users are able to control the online offer displayed at the dynamic node, while all other users are able to view and interact with the online offer displayed at the dynamic node according to rules defined by the authorized users. Access is controlled by enabling the administrator to establish rules relating to the online offer, enabling the administrator to allow at least one operator access to the offer management tool, enabling each operator allowed access to the offer management tool to generate online offer content, and determining if the generated online offer content is consistent with the rules established by the administrator, before posting the online offer.

The rules preferably include parameters defining the online offer, including at least a duration for which the online offer is to be available, a target audience to which the online offer is to be directed, an online location to which the online offer is to be posted, a specific good to which the online offer is directed, a specific service to which the online offer is directed, a dollar value associated with the online offer, a percentage associated with the online offer, and a size with which the online offer is to be displayed.

Preferably, the method also includes the step of linking the dynamic node to a shopping cart associated with the specific location, such that if a user viewing the online offer desires to make a purchase related to the online offer, the user is linked to the shopping cart. One embodiment also includes the step of linking the dynamic node to an inventory system associated with the specific location, such that if a user viewing the online offer desires to make a purchase related to the online offer, the purchase is deducted from the inventory system.

The present invention also relates to a system having elements that carry out functions generally consistent with the steps of the method for enabling an online offer to be displayed to a user in a networked environment by employing dynamic nodes linked to an offer management system described above. Another aspect is directed to an article of manufacture adapted for use with a processor and including a memory medium for storing a plurality of machine instructions. The plurality of machine instructions, when executed by a processor, cause the processor to carry out functions that are generally consistent with those steps described above for the corresponding method.

Yet another aspect of the invention is directed to a method for enabling a Web site to include online offers that are dynamically managed by an offer management tool. Such a method includes the steps of identifying at least one specific location on the Web site where online offers can be displayed, and then for each specific location identified, inserting a dynamic node, such that the dynamic node is dynamically linked to the offer management tool. Each dynamic node is integrated with a shopping cart associated with the Web site, thereby enabling a user desiring to make a purchase based on an online offer to be directed to the shopping cart. The method also preferably includes the step of integrating each dynamic node with an inventory system associated with the Web site, thereby enabling the inventory system to be updated if a user accepts an online offer that will affect the inventory system.

In one embodiment, the method also includes the step of defining a configuration of each dynamic node so that any online offer displayed by that dynamic node matches a style associated with the Web site. Preferably, this method includes the step of configuring each dynamic node so that when no online offer is displayed by that dynamic node, an appearance of the dynamic node on the Web site is minimized. Also preferably, the method includes the step of configuring each dynamic node so that only authorized individuals can make changes to the dynamic node and to any online offer displayed by that dynamic node.

Other aspects of the present invention relate to both a system and an article of manufacture, each including a memory medium storing a plurality of machine instructions, which when executed by a processor, cause the processor to carry out functions generally consistent with those steps described above.

Still another aspect of the present invention is directed to a method for enabling an authorized user to include an online offer at a specific location in a networked environment. This method includes the steps of selecting an online offer to be displayed, determining a specific location available in the networked environment where the selected online offer is to be displayed, and determining if a dynamic node exists at the specific location, such that the dynamic node is linked to an offer management tool. If no dynamic node is present at the specific location, the method generates such a dynamic node at the specific location. Next, it is determined if an existing online offer is being displayed by the dynamic node at the specific location, and if so, one of the following tasks is performed. These tasks include determining if the existing online offer is to be deactivated, and determining if display of the existing online offer is to alternate with display of the selected online offer according to a defined parameters. The method then determines if the selected online offer will fit in the dynamic node at the specific location, and if not, the method includes the step of configuring the selected online offer to fit the dynamic node at the specific location. Then the offer management tool is used to define activation and deactivation parameters that will control a display of the selected online offer at the specific location, and then the selected online offer is linked to the dynamic node at the specific location, such that the selected online offer is displayed according to the defined activation and deactivation parameters.

The method preferably also include the step of linking the dynamic node to a shopping cart associated with the specific location, such that if a user viewing the online offer desires to make a purchase related to the online offer, the user is linked to the shopping cart.

Additional aspects of the present invention relate to both a system and an article of manufacture generally corresponding in functionality to the steps of the preceding method.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a flow chart illustrating logical steps for using an offer management tool to insert dynamic nodes into a network, to generate online offers, and to manage online offers, in accord with the present invention;

FIG. 2 is a flow chart illustrating a sequence of logical steps for using a hierarchical based offer management tool to define, generate, and manage online offers in accord with the present invention;

FIG. 3 is a block diagram illustrating a preferred method of organizing different online offers into hierarchical relationships;

FIG. 4 is a flow chart illustrating a sequence of logical steps performed by an administrator using the hierarchical based offer management tool of FIG. 2;

FIG. 5 is a flow chart illustrating a sequence of logical steps performed by an operator using the hierarchical based offer management tool of FIG. 2, to generate on online offer;

FIG. 6 is a flow chart illustrating a sequence of logical steps performed by an operator using the hierarchical based offer management tool of FIG. 2, to locate an online offer at a specific location in a network;

FIG. 7 is flow chart illustrating a sequence of logical steps for using dynamic nodes to introduce online offers into a network;

FIG. 8 is flow chart illustrating a sequence of logical steps for enabling an existing Web site to be upgraded to be compatible with the offer management tool of the present invention;

FIG. 9 is flow chart illustrating a sequence of logical steps performed by the offer management tool of the present invention to introduce dynamic nodes into specific locations within a network;

FIG. 10 is flow chart illustrating a sequence of logical steps that the offer management tool employs to monitor the location of dynamic nodes at specific locations within a network;

FIG. 11 is an exemplary Web page including a plurality of online offers inserted into the Web page using the offer management tool of the present invention;

FIG. 12 schematically illustrates a relationship between content providers and content receivers enabled by a preferred embodiment of the offer management tool of the present invention;

FIG. 13 schematically illustrates a relationship between content providers and a sponsor in accord with the present invention;

FIG. 14 schematically illustrates a relationship between content providers, sponsors, and content receivers in accord with the present invention; and

FIG. 15 is a block diagram of a computer system suitable for implementing the present invention.

### DESCRIPTION OF THE PREFERRED EMBODIMENT

Specific nomenclature is employed throughout the following description for clarification, and to promote understanding of the present invention. Likewise, descriptions of specific embodiments are exemplary and should not be viewed as limiting regarding the scope of the invention. One embodiment of the present invention will be incorporated in a software application, OfferBuilder™, which will be distributed by AtkiNet of Bellevue, Wash. As implemented therein, the present invention will enable a creator of online merchandising offers to employ a single software tool to generate the content of online offers, to locate online offers at user-defined locations within a network, and to manage the display of online offers to network users. For simplicity, all further references to the OfferBuilder™ software refer to this software as the “System,” while other more basic embodiments of the present invention are referred to as either a “software tool” or an “offer management tool.” Although prior art Web site development software enables online offers to be inserted into HTML documents, multiple software tools have traditionally been required to generate, locate, and manage online offers. In contrast, the offer management tool and System of the present invention each accomplishes all of these functions in a single integrated tool.

The System provides multiple functionalities that enhance its capabilities for creating and managing online offers. For example, the System includes the ability to generate online offers, the ability to control access to the System according to a hierarchical structure of rights, the ability to integrate the System with existing Web site functionality (e.g., shopping carts) and inventory tools, the utilization of intelligent dynamic nodes that incorporate xyz locational intelligence, and other features that enhance the usefulness of the System with respect to managing online merchandising offers. Several of these functionalities will be discussed in greater detail below. It should be understood that not all functionalities of the exemplary application of the present invention are required. Since the software application that incorporates the present invention is relatively complex, it may be helpful to initially discuss only a subset of the full set of functions performed by the present invention.

In this initial simple explanation, the present invention is directed to a software tool (i.e. an offer management tool) that enables a user to insert a plurality of dynamic nodes at specified locations within a network (e.g., at user-defined locations on individual Web pages), and then manage the display of online offers at any of the dynamic nodes. As used herein, and in the claims that follow, the term “dynamic node” refers to a specific user-defined location on a network (e.g., on a Web page or other access point). A minimal amount of code is inserted into the HTML (or other programming language defining the Web page). The inserted code links the dynamic node to the offer management tool, thereby enabling a user of the offer management tool access to each such dynamic node. As will be described in detail below, some dynamic nodes may include code enabling the dynamic nodes to express xyz locational intelligence. Such intelligent dynamic nodes communicate with the offer management tool in order to specify the location of the intelligent dynamic node on a specific Web page. This location can be useful under circumstances in which a user of the offer management tool of the present invention has inserted an intelligent dynamic node at a specific location on a Web page (for example, at the top center of the Web page). Another user who has been authorized to modify the Web page may subsequently use a Web page editor included in the System to make changes to that Web page, resulting in the repositioning of the dynamic node with respect to other elements of the Web page. An intelligent dynamic node is able communicate to the offer management tool of the present invention that its present location on the Web page does not match the user-defined location.

An intelligent dynamic node is thus an area within an access point that is defined according to system coordinate positions and is set up to receive system content. The term “access point” refers to a self-contained, discrete block of source code that customarily displays as an element within a larger multidimensional presentation (e.g.; a frame within an HTML page, an HTML page within a Web site, a WML card within a wireless Internet deck, or an XML document within a digital sign sequence), as it resides in latent form on the server or other point of origin. The term dynamic node coordinate position refers to the dimensional location (e.g., x, y, z coordinates) of the dynamic node within the display area available for an access point (e.g., as determined by coordinates x=100 and y=150 on a Web page; or by other types of coordinates, such as x=2 and y=3 on a voice page, where x represents an audio duration in seconds, and y represents an audio volume in decibels). Clearly, the term dynamic node coordinate position applies only to intelligent dynamic nodes, as opposed to a more general dynamic node that does not exhibit positional intelligence.

The term “dynamic node position quantity” refers to the raw number of dynamic nodes reserved to appear within an access point, which affects the probability that system content, in the aggregate, will execute, appear, and/or be perceived/consumed during a user visit (e.g., this value can be increased if an intelligent dynamic node is placed in multiple slots within an access point). The term “dynamic node position quality” refers to the degree to which distinct system content in a dynamic node is likely to execute, appear, and/or be perceived/consumed during a user visit, given its relative position and other conditions within the access point (e.g., located near the top left of a Web page with few other distracting projects and/or little other content, or disposed near the beginning of a voice page).

Preferably an intelligent dynamic node may be configured such that it: (1) inherits and/or encapsulates (e.g., as in object oriented coding) awareness of its coordinate location within the access point relative to other dynamic nodes and/or other access point content; (2) exhibits polymorphism (e.g., also as in object oriented coding), allowing it to adapt its variables to resize, zoom, magnify, intensify, and/or otherwise accommodate multidimensional negotiations that minimize spatial/perceptual conflicts; (3) exhibits graphics, audio, video, animation, text, and/or multimedia content; (4) contextually requires certain user interaction(s) (e.g., a mouse over versus click versus double-click) depending upon one or more of the aforementioned characteristics, in order to trigger destination content display; and (5) dynamically manifests and guides or links the user to certain destination(s), triggered by user interaction(s), depending upon one or more of the aforementioned characteristics. For instance, an intelligent dynamic node may link to a certain destination and/or require a certain user interaction method, because it is aware that access point content display conditions exhibit a certain dynamic node position quantity and/or dynamic node position quality.

Regardless of whether the code used to insert a dynamic node at a specific location on a Web page includes such a locator component (i.e., whether a node is a dynamic node or an intelligent dynamic node), the same offer management tool is employed to insert the dynamic nodes, and to manage the activity at each such dynamic node. In the prior art, online offer content was inserted on Web pages in the following manner. A location would be selected for a particular offer, or group of offers. Code would be introduced into the Web page using an HTML editor application. That code would link either directly to offer content stored at a different location (i.e., a uniform resource locator (URL) would be inserted into the Web page, referring to the location of the online offer displayed to a network user when that Web page is loaded), or link to a simple routine such as a Web bot that determines which one of a plurality of different online offers will be displayed to a network user when that Web page is loaded. In the prior art, dynamic nodes are not pre-positioned to be available to be filled with online offers at a later date, the processes of defining a location and the process of linking that location to offer content or a routine controlling the display of a plurality of different content are not decoupled. Nor in the prior art is the routine controlling the display of different content part of the same offer management tool used to insert the code in the HTML of the Web page. Finally, note that the prior art does not disclose the locator component of an intelligent dynamic node.

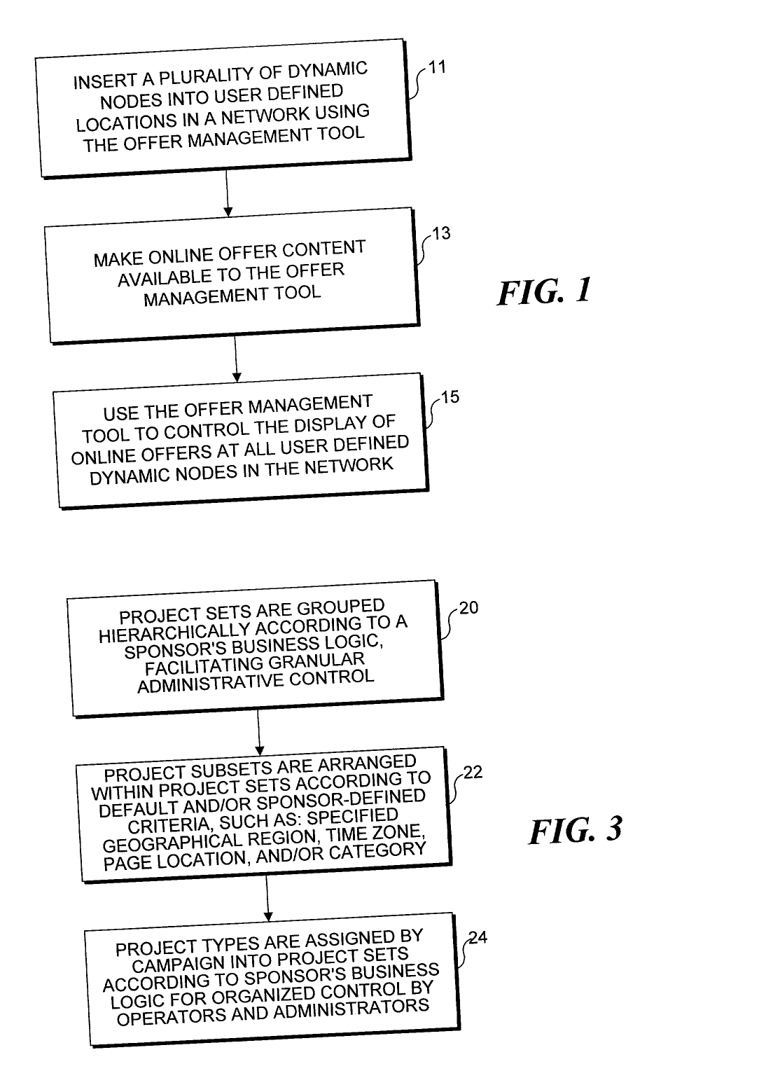

Thus, the present invention is directed to a method for managing online offers that use the same offer management tool to insert dynamic nodes at locations within a network, and then to manage the display of online offers at those dynamic nodes using the offer management tool. FIG. 1 is a flow chart illustrating the steps employed in the present invention. In a block 11, a user employs the offer management tool of the present invention to insert dynamic nodes into user-defined locations within the network. As noted above, dynamic nodes are generated by inserting code into the HTML of a Web page linking that dynamic node to the offer management tool. In a block 13, online offers are made available to the offer management tool. The offer management tool itself is used to generate the online offer content, but online offer content generated by other applications (such as an HTML editor) can alternatively be used. Then, in a block 15, the user employs the offer management tool to control the display of online offers at any of the user-defined dynamic nodes. Merely by manipulating the offer management tool, any of the online offers available to the offer management tool can be displayed at any dynamic node linked to the offer management tool. The code defining the dynamic node at each Web page does not need to be updated, as the link to the offer management tool enables the offer management tool to define which offer, if any, is displayed at any one of the dynamic nodes. Preferably, if a dynamic node in a Web page is not instructed to display any content, the offer management tool “shrinks” the apparent size of the dynamic node to a single pixel, so that a user viewing the Web page is not presented with a blank frame, or the “x'ed” out block indicating that an image is unavailable.

It is contemplated that the offer management tool will control the display of content in a dynamic node according to many different user-definable parameters. For example, display of content at a specific dynamic node might be activated only at certain times of the day, or the online offer displayed at a dynamic node might be changed according to a user-defined schedule, or, specific online offers might be targeted to a particular network user, based on a user profile of that network user.

While FIG. 1 refers to a basic embodiment of the offer management tool of the present invention, the following discussion relates to an embodiment of the present invention in which access to an offer management tool for managing online offers is controlled using a hierarchical management system. The System incorporates both the dynamic nodes and the hierarchical access elements. Preferably, the System is a comprehensive incentive merchandising software platform residing on a computer server that hosts the System's online application and database. The System integrates with a Sponsor's e-commerce, sales and marketing infrastructure, through a multitude of programmable, interactive links.

The System is preferably accessed by three general classes or levels of participants, including: (1) administrators who, on behalf of Sponsors, configure global and granular roles, groups, subgroups, rules, policies, procedures, oversight and/or technical support; (2) operators who, individually or as a collaborative group or subgroup, perform account administration and incentive merchandising functions related to designing and maintaining the content and features displayed by the System; and (3) users with varying interests, who visit, view, access and consume the content and interact with features displayed by the System. Note that the term “users” here refers to network users who access network content (e.g., Web pages) that include dynamic nodes, which actively display online offers managed by the System. The System is designed to include hierarchical levels of access, so that a small number of administrators can manage larger numbers of operators, and still maintain control over the types of offers being generated and introduced to the network. This is an important point, because online offers can potentially reach a huge audience, with significant economic implications for the sponsor of the offer.

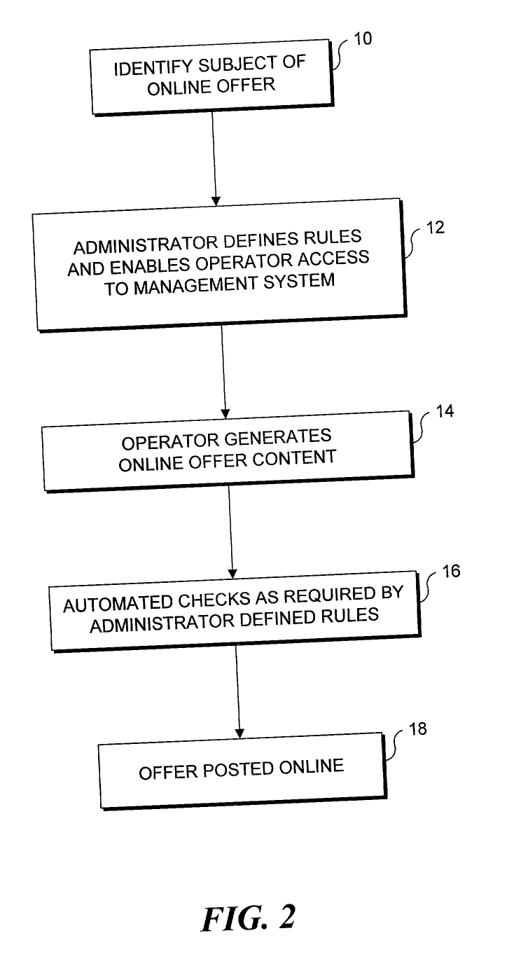

FIG. 2 is a flow chart diagram illustrating the logical steps implemented in the present invention to enable a single software tool to hierarchically generate and manage online offers. In a block 10, an online offer is conceptualized and identified. In a block 12, an administrator defines a set of rules regarding that online offer, and inputs those rules into the offer management tool. Such rules, which will be discussed in greater detail below, may include limits on the time the online offer is to be valid, and other specific details of the online offer. The administrator also enables one or more operators to have access to the offer management tool. In a block 14, the authorized operator will use the offer management tool to generate an online offer consistent with the concept and the rules defined by the administrator. Preferably, the operator will match a style of the online offer to a style of the Web page into which the online offer will be inserted. In a block 16, the offer management tool executes a self check to ensure that the online offer generated by the operator is consistent with the rules defined by the administrator. As will be discussed in detail below, these checks may include enabling other personnel to review and approval of an online offer, such as representatives from a legal or financial department. Finally, in a block 18, the online offer is posted online, according to parameter defined by the administrator (who may also be an operator, if no other operators are defined by the administrator). In the System, dynamic nodes will be used to locate (i.e., to insert offer content onto Web pages) and manage online offers.

Preferably, the offer management tool is useful in managing not only hierarchical access to the offer management tool, but will also track and associate different online offers in a hierarchical fashion. FIG. 3 is a block diagram illustrating a preferred approach for organizing a plurality of different online offers as projects. The System preferably includes features to facilitate the management of large numbers of online offers. A block 20 indicates that projects, preferably comprising ads, offers, catalogs, and campaigns, may be organized in sets and stored in online directories according to the sponsor's business logic, facilitating granular administrative control. Project sets may be organized in many ways; for instance, projects may be filtered, grouped, searched, sorted, and/or summarized by division, department, product, access point, and/or category. Projects subsets may further be defined within project sets, as indicated in a block 22. Thus, for instance, projects subsets within a project set may be filtered, grouped, searched, sorted, and/or summarized by event, geographical region, time zone, page location, and/or category/subcategory.

The System also enables projects to be organized by project type, as indicated in a block 24, such that ads, offers, catalogs, and campaigns may each be filtered, grouped, searched, sorted, and/or summarized by type. Ads and catalogs are preferably defined as secondary project types, with campaigns being defined as a tertiary project type, each of which supports the successful distribution of each offer, which is defined as a primary project type. Offers promote products and services that are correlated with the offers. In turn, ads promote offers and/or products and services that are correlated with the offers. Catalogs group ads and/or offers according to the sponsor's business logic for organized display to users. Further, campaigns preferably group ads, offers and catalogs into a primary project set according to the sponsor's business logic to provide operators and administrators with organized control over primary and secondary project types. Thus, projects must be placed in a campaign (i.e., one mandatory primary project set, facilitating granular administrative control), and may be placed in one or more optional (i.e., secondary; matching group discrimination criteria) project set(s)/subset(s), allowing flexible reports, analyses, and alerts. Placement of a campaign in a project set that is defined as its primary project set may be altered. Thus, a campaign's existing (e.g., default) primary project set may be changed to another eligible, defined project set if allowed by administrative level system rules. Automated and manual changes to project status settings (i.e., publish mode of either active or inactive and/or workflow category such as: normal, critical, to schedule, in process, on hold, revising, planning, ideas) can cascade over project sets and/or project subsets.

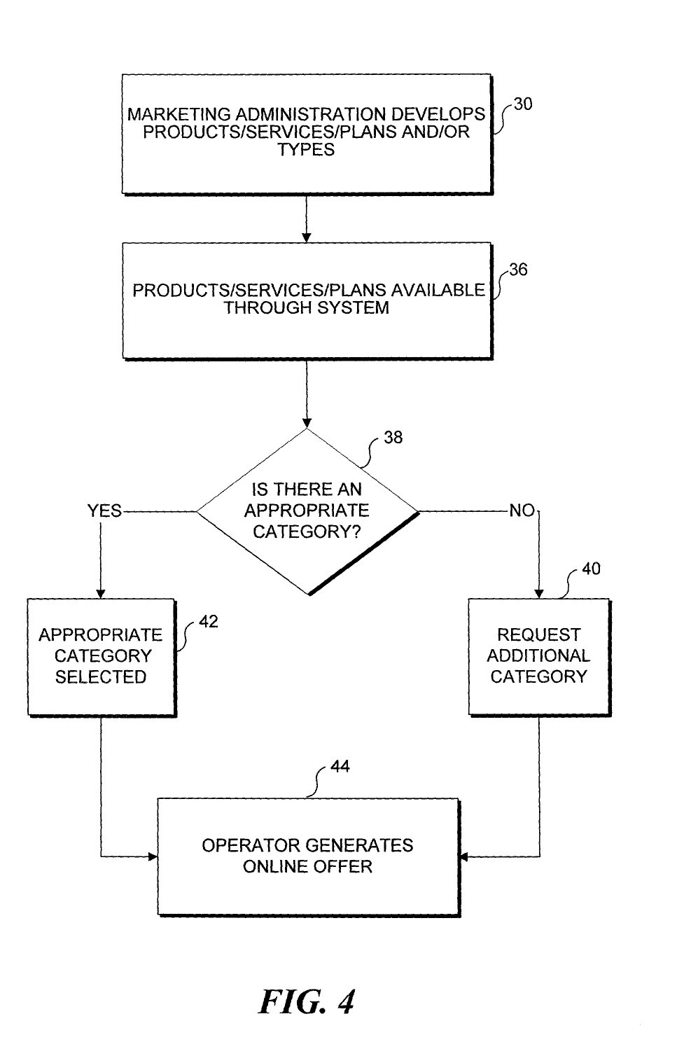

FIG. 4 provides additional details of a preferred manner in which an administrator can manage the tasks of conceptualizing online offers, and defining rules, each of which are broadly indicated in blocks 10 and 12, respectively, of FIG. 2. Preferably, marketing administrators structure, categorize, and package global products/services/plans, which are offered to system operators and/or members through commercial purchasing options and/or internally rationed organizational purchase proxies (e.g., using points).

In a block 30, marketing administrators may preferably define product/service/plans and/or types, which are frameworks for associating system-derived benefits with system-mediated benefits (e.g., training combined with projects and space on access points) for consumption by operators. Although operators are the primary audience, as the operators will be generating content based on such frameworks, users and members may be also be targeted as consumers for products/services/plans (i.e., with limited delegated capability). System-derived products (such as system on media, device/hardware (e.g., CD, hard drive, read only memory (ROM)), system in software bundle/package, and system with platform (e.g., software/hardware bundle)) may be combined with system-derived services (such as training, consulting, and support, or leasing, hosting, and infrastructure), and system-defined plans.

Marketing administrators determine plan types and plans, which logically bundle system components (e.g., projects and forms combined with specific levels of user capability) and are subsequently packaged for acquisition (i.e., purchase and/or purchase proxy) by operators. The plan initialization process preferably allows marketing administrators to determine elements and aspects of a plan that merit data capture at the user interaction level, which feeds reports, analyses, and alerts. For instance, the marketing administrator may decide that, for a given plan, tracking (i.e., capturing data for) project elements is not only relevant but may be packaged and marketed such that only more expensive plans feature granular reporting, analysis, and alerts. On the other hand, mid-level plans may be structured such that general tracking is allowed by project only, and entry level plans (e.g., teasers) may not allow tracking at all, so that reporting, analysis, and alerts are entirely disabled. Similarly, variations in device profiling capability may be packaged and marketed as a differentiating plan feature. Again, in some cases marketing administrators may target users and members; for instance, access to helpful shopping trends across the System may be offered to attract paid members. Furthermore, monitoring/tracking parameters related to purchase of the product/service/plan itself (e.g., profile of purchasing operator, order time, order quantity) may be grouped into System-generated reports and analysis that may then be set to automatically notify administrators by alerts, which are sent via pop-ups and/or e-mail/messaging.

In a block 36, these products/services/plans and/or types are made available to others on the System, according to the hierarchical access control described above. For example, only certain operators (or specially delegated users or members, as described above) may be allowed access to a particular products/services/plans and/or types.

Preferably, the administrator first uses the System to determine if an appropriate product/service/plan and/or type (i.e., a category as shown in FIG. 4) exists that corresponds to a specific online offer in a block 38. If not, then in a block 40, the administrator uses the System to create such a product/service/plan and/or type, and the offer is grouped accordingly. If so, then in a block 42 the appropriate existing category is selected for an online offer. In a block 44, one or more operators are assigned to generate the online offer. Preferably, categories and subcategories within types (i.e., regional and national plans under the active promote plan type) assist operators in comprehending the intent and scope of available products/services/plans. Attributes, which may be determined when each new product/service/plan is created (e.g., product image display at the points-of-purchase/-commitment), feed into the System's market display, where operators shop for products/services/plans after filtering, grouping, searching, sorting, and summarizing purchase options.

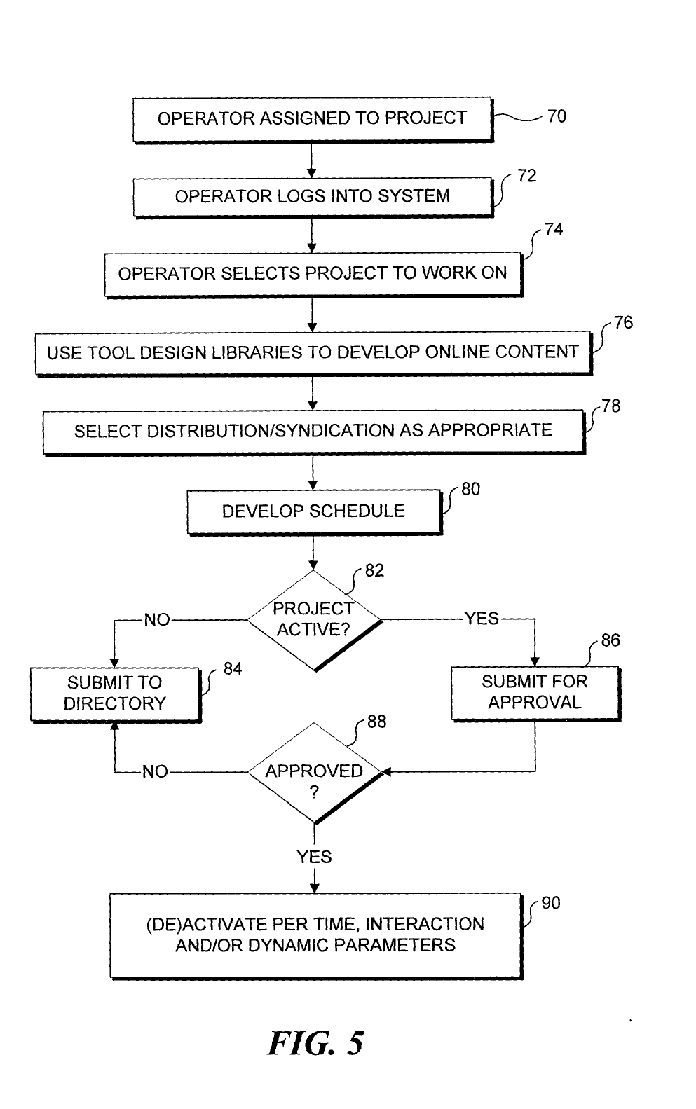

FIG. 5 is a flow chart illustrating a sequence of logical steps employed in at least one embodiment of the present invention to enable an operator to generate content for an online offer, as is required in block 14 of FIG. 2. In a block 70, an operator is assigned to a specific project. Note that individual operators may be tasked with multiple projects. In a block 72, the operator accesses the online offer management tool, with secure log in access. In a block 74, the operator determines the Project on which to work. Projects preferably can include ads (comprehensive, targeted, or precision), offers (regional or national), and or catalogues (regional or national). Preferably, operators are able to view and edit projects (ads, offers, or catalogues) through a control panel in a preferred embodiment of the present invention. Operators may execute entry and edit functions related to images, destinations, positions, and reference notes, and entry and edit functions that, for each offer, control activation variables for templates and types as well as aesthetic variables for corresponding multimedia and graphic presentations. Access to control functions may be made available for use by operators to the degree permitted by the corresponding plan environment. For instance, a plan a permitting comprehensive placement of ads may not display the function that controls the targeted positioning of the ads in correspondence with page location parameters declared through the System, whereas a plan permitting targeted placement of ads may include such control.

In a preferred embodiment of the present invention, an offer ID, an incentive type, a category/subcategory, and target region parameters may not be changed once established (default terminal configuration), unless permitted by administrators (e.g., once an offer project is designated as a coupon, it cannot be converted to a gift certificate). By default, company name is taken from the operator profile and, if permitted by administrators, may be edited to match the contents of each offer to optimize search performance. These default system settings, and other defaults such as initial image names, image slots, relative image positioning, and permitted image sizes, are predefined by the System and ultimately (re)defined by administrators unless delegated to operators.

In a block 76, the operator employs the offer management tool to develop content for the online offer. Preferably, the offer management tool includes design libraries and/or tool kits that enable an operator to readily develop the online offer content. Preferably offer types and templates applied to each offer may be customized by inserting borders, text, images, graphics, control buttons, audio, and/or video or animation files, as linked objects. Depending upon the type of presentation, the System allows modification of corresponding style variables, including color, size, thickness, justification, location, font, duration, or volume, as integrated with each offer. In at least one embodiment, operators may save customized activation, aesthetic, and/or functional user interface customizations, and other contributions to System design libraries, so that such content may be shared with other operators. Preferably, defaults, such as initial border color, text size, font, and sound volume are predefined by the System, but may be ultimately (re)defined by administrators unless that task is delegated to operators. The System supports these operations using pull down menus and point and click interfaces. The offer management tools enable operators to utilize project tools, to control the labeling, aesthetic design (e.g., button color, font size), display mode (e.g., text link instead of buttons), relative position, and optional appearance of CLIP, VIEW, SHOP, NET, PHONE, and/or PRINT interface elements, based upon the operator's merchandising criteria/intent and/or the type of device the user is expected to utilize when activating the offer. Preferably, interface elements not employed or populated either do not appear in the user interface or may be configured to display in a different shade/color/form (e.g., grayed out, faded, or shaded) to indicate that they are inert and without activation links.

In at least one embodiment, developing online offer content includes the following configuration steps for controlling the content portion of the online offer. The offer management tool preferably includes tools for including CLIP and SHOP functions in the online offer. CLIP functionality enables a network user to “clip” and save an online offer much in the way a newspaper reader “clips” coupons for later use. SHOP functionality enables a network user to link to or otherwise access different techniques for purchasing an item (i.e., telephone sales, online sales, etc.).

CLIP controls transfer truncated and/or otherwise summarized information from the corresponding offer to an OfferBook, prompting users who are members to save session OfferBooks to their account; CLIP by VIEW Controls optimize offer content for writing details without printing and/or low-end, limited-display devices (i.e., excluding graphics and text not required for redemption); CLIP by PRINT controls optimize offer content for printing and/or high-end, limited-display devices (i.e., excluding graphics not required for redemption).

Configuration for the SHOP interactive portion of the user interface is preferably structured as follows: SHOP controls assist/guide operators by facilitating technology connections (e.g., direct e-commerce, e-conferencing, member profile, and/or shopping cart links) with sponsor/partner organizational resources (e.g., automated fulfillment and/or customer service personnel) that are equipped to receive and respond to user responses (i.e., sales); SHOP by NET controls assist/guide operators by facilitating technology connections (e.g., e-mail and/or link address entry slots) with sponsor/partner organizational resources (e.g., fulfillment or customer service personnel) that are equipped to receive and respond to user responses (i.e., leads, sales); SHOP by PHONE controls assist/guide operators by facilitating technology connections (e.g., phone number, e-mail and/or link address entry slots) with sponsor/partner organizational resources (e.g., fulfillment or customer service personnel) that are equipped to receive and respond to user responses (i.e., leads, sales). Preferably operators view and edit interaction oriented SHOP interface elements of offer projects through a control dialog in a preferred embodiment of the present invention. Operators may execute entry and edit functions that, for each offer, control activation variables for NET and PHONE interface elements.

Referring once again to FIG. 5, once the online offer content is completed in block 76, in a block 78, the operator is enabled to select distribution and syndication options. In a block 80, the operator selects a schedule that will be used to control the display of the online offer to the network. For example, an operator, based on instructions (i.e. rules) determined by an administrator, will determine scheduling information to be used to display the online offer, such as display for 48 hours, starting Monday at 7:00 A.M., then wait for 48 hours and display again for a specified time period.

In a block 82, the operator determines if the project is “alive.” In other words, the operator determines if the content is complete and ready to be distributed online, or if additional work is required. Projects that are not alive are stored in a directory in a memory accessible to the online management tool in a block 84, while projects that are alive go through the approval process described above (i.e., the approval in block 16 of FIG. 2), in a block 86. From block 86, the operator then determines if the project has been approved in a decision block 88. If the project is not approved, the project is again stored in a directory in a memory accessible to the online management tool in a block 84. Projects that have been approved are posted online by the operator using the offer management tool, according to activation and deactivation parameters in a block 90. Preferably, the activation and deactivation parameters are defined by the administrator as part of the rules defined for each project. If not incorporated into such rules, then the operator can define the activation and deactivation parameters. Such activation and deactivation parameters will include time intervals (months, weeks, days, hours, minutes, etc.), interaction parameters (i.e. an online offer will be displayed until a predefined number of hit or clicks has been achieved, or until a predefined number of purchases have been made), and dynamic events (i.e. other criteria that can be extracted from Internet data storage, processing, transfer and/or display events).

In a preferred embodiment, once an operator submits an online offer (i.e. a project) for approval in a block 86, the online offer tool automatically executes the approval process and either posts the offer online according to the defined activation and deactivation parameters, or saves the online offer to the directory discussed above. In at least one embodiment, the approval process merely checks the online offer generated by the operator against the rules defined by the administrator, which can be executed rapidly. In other embodiments, approval requires review by another individual, such as a designee in a legal or a finance department, or perhaps by an administrator who wants to monitor a new operator's performance. In such a case, the approval process might require hours, or even days. Preferably, while such completed but not yet approved projects are pending, they are stored in the directory.

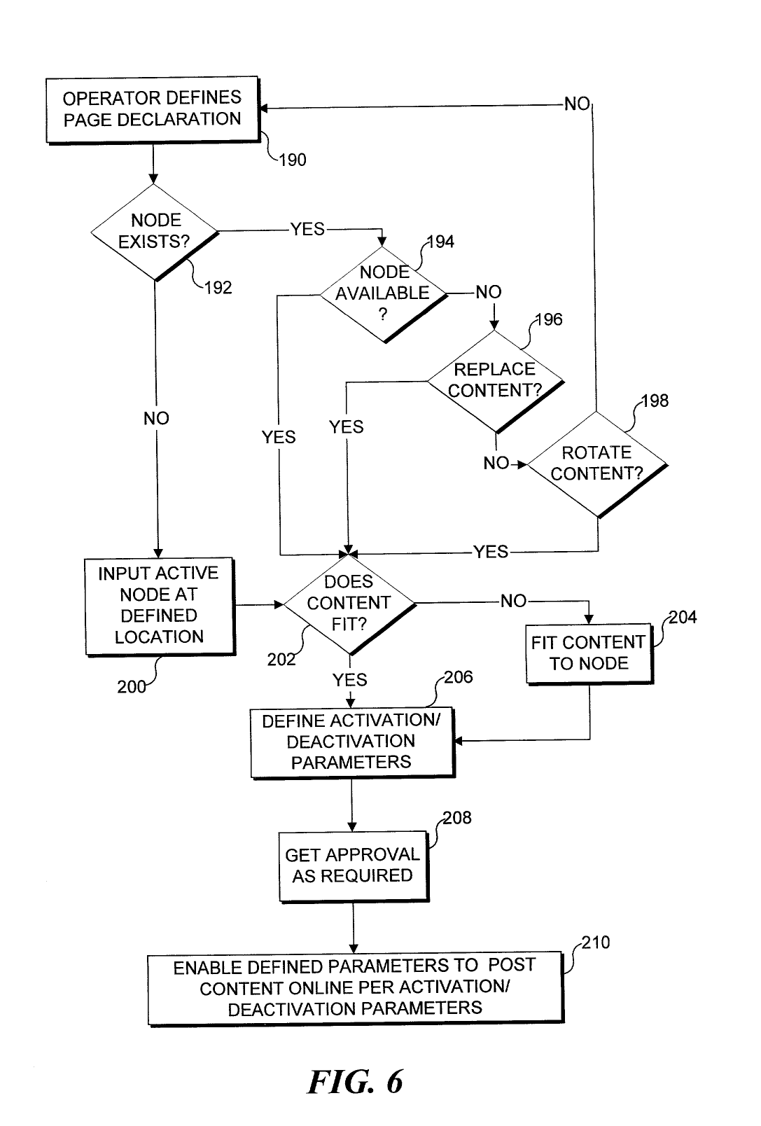

FIG. 6 is a flow chart illustrating a sequence of logical steps employed in at least one embodiment of the present invention for an operator to locate, generate, and activate online offers. In a block 190, an operator determines a specific network location at which an online offer is to be displayed. In a decision block 192, the online management tool determines if a dynamic node exists at the desired location. If not, the operator uses the online management tool to input a dynamic node at the desired location, in a block 200. Then, in a decision block 202, the size of the online offer to be introduced into the newly inserted dynamic node is checked, to determine if the content fits on the Web page on which the selected dynamic node is disposed. This step is preferably accomplished by the offer management tool copying the existing Web page into a buffer, then introducing the content of the online offer into the copy of the Web page to determine if any size conflicts arise. In a preferred embodiment, this copy will be visually displayed to the operator.

If, in decision block 192, the online management tool determines that a dynamic node exists at the desired location, then the online management tool determines if the dynamic node is available (i.e., if it is empty—that no online offer is presently being displayed, or is scheduled to be displayed) in a decision block 194. If the dynamic node is available, then in a decision block 202, the size of the online offer to be introduced into the dynamic node is checked, as described above.

If, in decision block 194, it was determined that the selected dynamic node is unavailable, then in a decision block 196, the operator is prompted to selectively disable or replace the existing online offer in favor of the currently selected online offer. If the operator elects to replace the existing online offer with the new online offer, then the content size check of decision block 202 is performed.

If, in decision block 196, the operator elects not to replace the existing online offer with the new online offer, then in a decision block 198, the operator is prompted to selectively rotate or alternate the display of the existing online offer with the currently selected online offer. If the operator elects to rotate the display of the existing online offer with the new online offer, then the content size check of decision block 202 is performed. If the operator elects not to rotate the display of the existing online offer with the new online offer, the operator is returned to block 190 and prompted to select a different dynamic node, as the currently selected dynamic node is already in use, and the operator has affirmatively elected not to replace or rotate the existing content.

Referring again to decision block 202, if it is determined that a size conflict exists, then in a block 204, the content is manipulated to fit the space available at the selected dynamic node. The next step 206 defines the activation and deactivation parameters that will trigger the display of the online offer at the selected dynamic node. The parameters can be time based (i.e., display the online offer for 48 hours, or from 9:00 P.M.-1:00 A.M. Friday through Monday, or apply some other time parameters desired by the operator or defined in the rules setup by the administrator), or based on user interaction (i.e., display the online offer until 500 hits have been achieved, or until 500 units have been ordered through a shopping cart or inventory system linked to the online offer). Note that if in decision block 198, the currently selected online offer is to be rotatably displayed or alternate with an existing online offer (i.e., if the old offer is be displayed for a defined time period, then the new offer is to be displayed for a defined time period in a cyclical fashion), then the parameters defining how often the online offers should be switched need to be defined. The offer management tool prompts the operator to select each required parameter.

In a block 208, the online offer must be approved as discussed above. Once approved, the selected parameters are enabled at step 210, and the online offer will be displayed according to the selected activation/deactivation parameters.

Additional details relating to administrator and operator activities, preferably facilitated by the detailed offer management tool referred to as the System (as opposed to a basic offer management tool) are provided below.

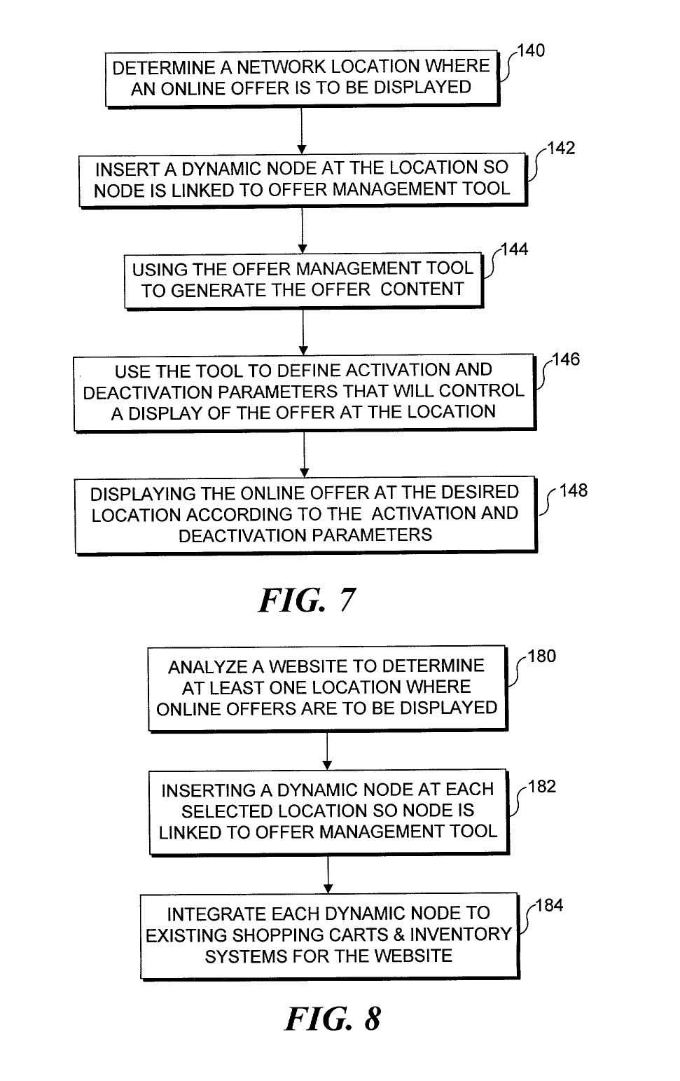

As indicated above, the present invention is directed toward the use of an offer management tool to: (1) insert dynamic nodes into specific locations within a network); (2) generate online offer content; and (3) control the display of online offers at any of the dynamic nodes. FIG. 7 shows a sequence of logical steps used to carry out these functions. In a block 140, a user wishing to introduce online offers into a network selects a specific location in the network where an online offer is to be displayed. In a block 142, a dynamic node is introduced at that location. Note that a key element of a dynamic node is that dynamic nodes actively link to the offer management tool of the present invention. In a block 144, the offer management tool is used to generate the online offer content and, in a block 146, the offer management tool is used to define activation and deactivation parameters that will control the display of an online offer at a specific dynamic node. In a block 148, a selected online offer is displayed at a selected dynamic node according to the defined activation and deactivation parameters.

It is contemplated that an individual or an organization controlling a Web site comprising a plurality of different Web pages will desire the ability to incorporate and manage online offers at a plurality of different locations on the Web site. The offer management tool of the present invention enables Web site owners to preposition dynamic nodes at a plurality of locations on the Web site, to develop online offers using the offer management tool, and then, at will, activate or deactivate the display of online offers at any of the dynamic nodes on the Web site. FIG. 8 shows a sequence of logical steps used summarizing such steps. In a block 180, a Web site owner wishing to introduce online offers into his Web site at some future time selects one or more specific locations on the Web site where an online offer could be displayed. In a block 148, a dynamic node is introduced at that location. Again, note that dynamic nodes actively link to the offer management tool of the present invention. In a block 184, the offer management tool is used to link each dynamic node into any existing shopping carts or inventory systems currently serving the Web site. This step enables any online offer developed for the Web site using the offer management tool of the present invention to be readily integrated with existing shopping carts and inventory management tools.

Integration of each dynamic node with distinct external inventory, accounting and e-commerce/payment systems (e.g., shopping cart or enterprise resource planning), which depend on the contextual placement and/or point-of-contact within each access point may preferably be specified by operators, if permitted by financial administrator(s). In such cases, financial configuration tasks may be explicitly delegated, partially or completely, from financial administration, enabling operators to replace default system settings for one project or across several projects (i.e., sets, subsets). Since the overriding defaults may require the System to transfer the content, business logic, and/or semantic data to external processing protocol(s), the System preferably provides flexible outbound data feeds and hooks (e.g., API, Java, and/or XML code output for export and/or automated transfer) on a case-by-case basis (e.g., filtered, grouped, searched, sorted, and/or summarized by table, multiple variables, variable type, and/or variable).

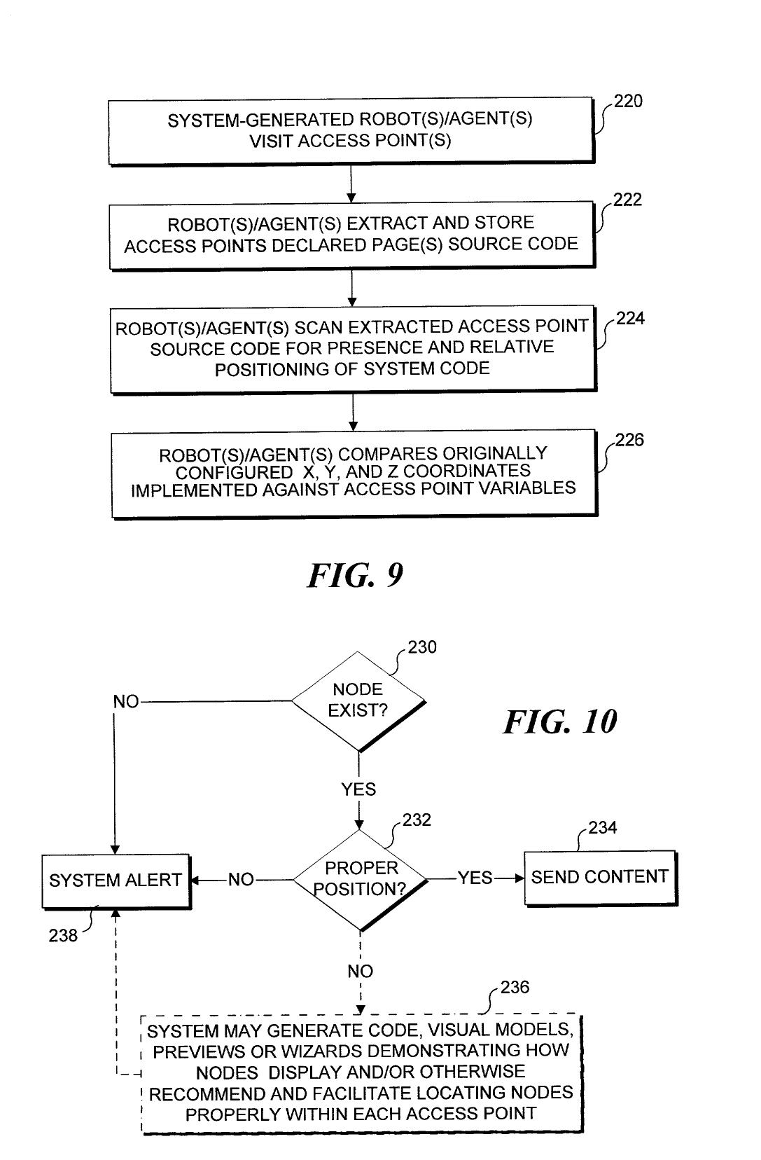

FIG. 9 illustrates a preferred sequence of logical steps used to insert dynamic nodes at desired locations. Initialization of the entire network of dynamic nodes, as well as dynamic nodes that may be added subsequently as needed, is preferably actuated by System-generated robot(s)/agent(s) that visit the declared access point(s), extract the source code from each access point to System storage; scan the extracted source code for the presence and relative positioning of System code, and compare the permitted x, y, and z coordinate range (e.g., subdivided display size range for the intended form factor(s)) for each access point as specified within variables in the dynamic node implementation (i.e., System code as placed within the access point) against actual placement within the access point using the corresponding original dynamic node declaration stored on the System as the auditing frame of reference. In a block 220, System generated robots visit the Web pages identified with the selected location, and in a block 222, the robots extract and store that Web page's source code. In a block 224, the robots scan the extracted source code for relevant positioning code, and in a block 226, the robots compare the originally configured x, y, and z coordinates against the Web page variables.

If the dynamic node has not yet been placed within the access point, or if the dynamic node is not likely to display properly (e.g., due to inadequate space and/or because it is placed at coordinates, which diverge from the original declaration) when the System robot(s)/agent(s) visits, the System notifies (e.g., via reports, analyses, and/or alerts) the appropriate operator(s) and/or administrator(s). The System may generate code (e.g., prototype models of the access point source code, with dynamic node(s) automatically inserted), visual models, previews and/or supply wizards demonstrating how dynamic nodes display, and/or otherwise recommend and facilitate locating dynamic nodes within each access point. This logical sequence of steps is illustrated in FIG. 10. In a block 230 the offer management tool determines whether a dynamic node already exists at a location identified by a user of the offer management tool as a location where an online offer is to be displayed. If no dynamic node is present at that location, an alert is sent to the operator (and/or administrator) in a block 238. If a dynamic node is present (such as one inserted via the steps of FIG. 9), the offer management tool determines if the dynamic node is properly positioned, in a decision block 232. Note that changes to a Web page content after a dynamic node has been inserted may change the position of the dynamic node on that Web page. Preferably, the position check also determines if other Web page content may interfere with the display of the online offer scheduled to be displayed in the dynamic node that has been selected.

If it is determined that the positioning is acceptable, in a block 234, the content of the online offer is displayed at the Web page under the control of the offer management tool (i.e., per the parameters controlled by the offer management tool). If the positioning is not correct, an option step represented by block 236 provides that the offer management tool “suggests” corrective actions. Such suggestions may include generating code to correct the positioning fault, generating previews, visual models, or wizards demonstrating how the dynamic node displays in the Web page, or otherwise recommending or facilitating proper positioning.

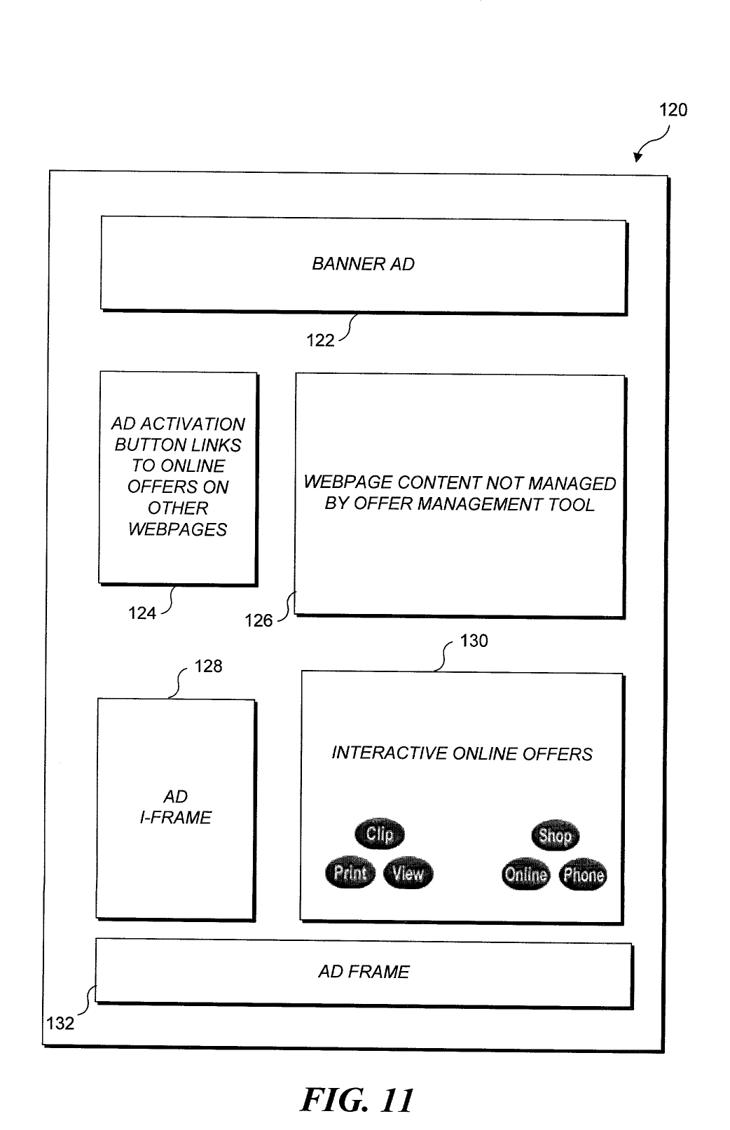

FIG. 11 illustrates an exemplary Web page 120 that includes online offers managed by the offer management tool of the present invention. A block 122 is where a banner ad has been added to the Web page using a dynamic node linked to the offer management tool of the present invention. The present invention enables clients to post such banner ads promoting online offers and controls banner ad content, appearance, and scheduling. When no content is scheduled for block 122, the banner ad either collapses (e.g., disappears as the larger image is replaced with a smaller image, perhaps one pixel that is barely discernable and/or transparent) and is preserved for later activation, or a default/generic banner is instead inserted in block 122. A block 124 represents an ad activation button that has been inserted into Web page 120 using a dynamic node linked to the offer management tool. Such ad activation buttons link to online offers residing on other Web pages. The offer management tool generally controls activation button content, appearance, and scheduling in a similar manner to that with which it controls banners.

A block 126 represents online content not managed by the offer management tool. For many Web pages, such content represents the primary content (i.e., the content that originally attracts network users to the Web page). For a Web page devoted to non online offer content (such as a Web page devoted to collecting baseball cards), the content will appear in block 126. Note that block 126 generally will occupy the majority of the Web page, and the online offer blocks (blocks 122, 124, 128, 130, and 132) will typically occupy considerably smaller portions of Web page 120. It should also be noted that while all of the blocks (i.e., blocks 122, 124, 128, 130, and 132) representing dynamic nodes that can be used to insert online offers onto Web page 120 may be active (i.e., displaying an online offer) at one time, more frequently, not all of the dynamic nodes will be displaying online offers at the same time. Of course, if the Web page is primarily directed to displaying online offers, then most of or all of the block might be active and simultaneously displaying online content.

A block 128 represents an ad I-frame that is controlled by the offer management tool of the present invention. Such ad I-frame slots can be used to promote online offers. The offer management tool controls I-frame content, appearance, and scheduling. When no content is scheduled for this I-frame slot, default/generic content preferably appears (as opposed to the I-frame being minimized so as to disappear from view).

A block 130 represents yet another type of online offer that can be inserted into Web page 120 using a dynamic node linked to the offer management tool. Note that the online offer represented by block 130 allows direct access to interactive offer functionality such as interaction channels and cross-promotions (i.e. CLIP, PHONE and SHOP functionality, enabling users to clip offers for later use, to phone a vendor to take advantage of an online offer, or to shop and be automatically connected to the vendor's online shopping cart functionality). The offer management tool controls the online offer content, appearance, and scheduling. When no content is scheduled for this slot, default/generic content preferably appears.

Yet another online offer is represented by a block 132, which shows an ad frame slot promoting an online offer. As noted above, the offer management tool controls frame content, appearance, and scheduling. Preferably, when no content is scheduled for this frame slot, default/generic content appears, or the offer management tool is used to minimize the size and appearance of the ad frame.

Note that the offer management tool is first used to insert dynamic nodes at blocks 122, 124, 128, 130, and 132, to generate online offer content, and finally, to control the display of online offers at each of blocks 122, 124, 128, 130, and 132. At any given time, based on parameters controlled by the offer management tool, any of these blocks can either be actively displaying an online offer, displaying static or default content (i.e. content not necessarily related to an online offer), or be minimized in size so as to be unobtrusive to a network user.

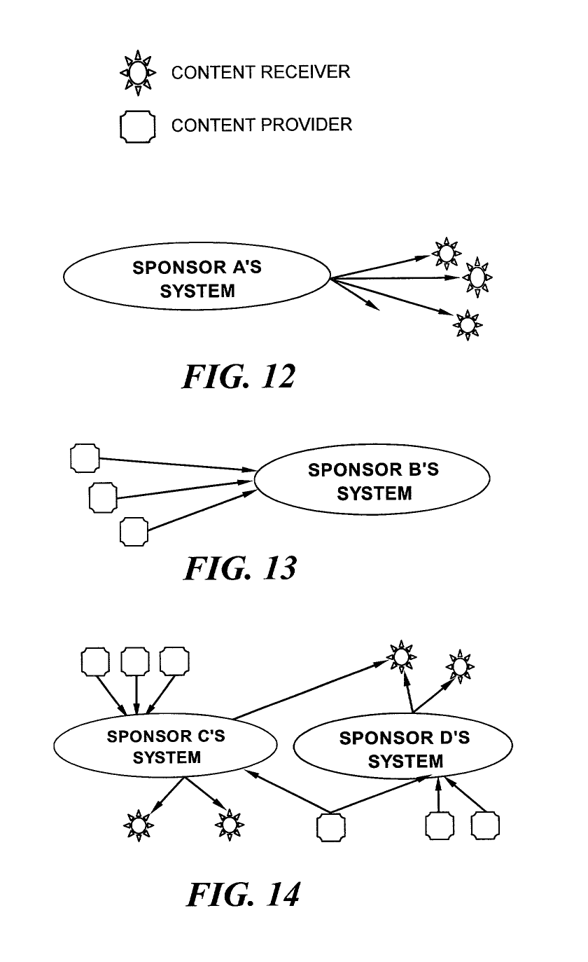

FIGS. 12-14 schematically illustrate relations among content providers and content receivers facilitated by a preferred embodiment of the present invention. The System-mediated arrangements among multiple sponsors, each with affiliated/internal and/or unaffiliated/external partner access points, may display projects on each others' access points as content receivers and/or as content providers. In a preferred embodiment of the present invention, sponsors may utilize inbound and/or outbound distribution based upon contextually-appropriate, sponsor-defined commercial arrangements between the participating parties. Thus, sponsors may act simultaneously as content receivers and content providers. Preferably, relationships between sharing sponsors and partners may be distributed, sorted, filtered, or viewed by geography/location, product categories/types, service categories/types, delivery terms (e.g., timeliness or coverage), order volume (e.g., quantity), price (e.g., ranges, or currencies, rates), quality (e.g., standards, ratings, or specifications), reliability (e.g., standards, ratings, or history), or sponsored-defined criteria.

Distribution arrangements may be allocated and/or rationed through product/service/plan packages, which allow content receivers and/or content providers to negotiate and set their content display price then bill the counteracting content receivers/providers for any amount owing. Preferably, receivers and providers may select from a variety of common or mutually agreeable payment methodologies, such as invoice, credit card, debit card, electronic funds transfer, pay by check, scrip, points, or cashless exchanges. System transaction records may be directly transferred into e-commerce, accounting, and inventory infrastructure controlled by content receivers and/or content providers.

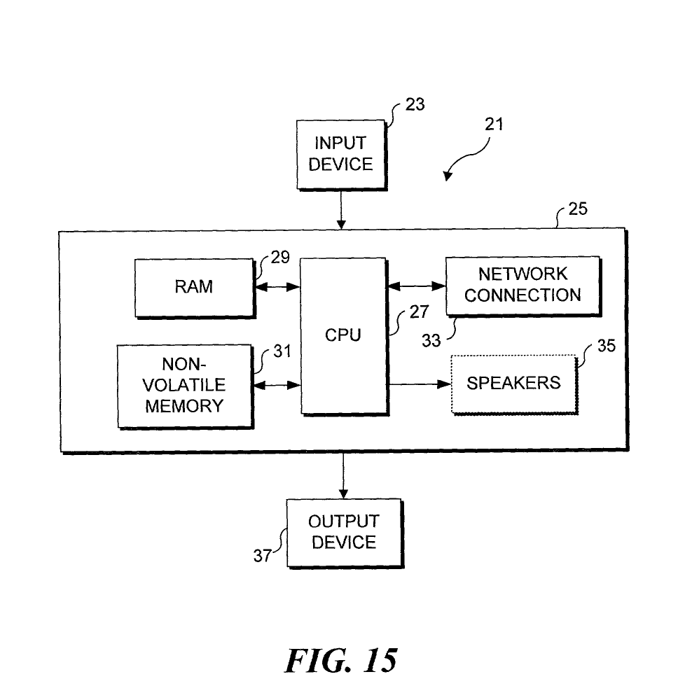

FIG. 15 and the following related discussion are intended to provide a brief, general description of a suitable computing environment for practicing the present invention. A preferred embodiment of an offer management tool is executed on a personal computer or other computing device with access to the network environment. Those skilled in the art will appreciate that the present invention may be practiced with other computing devices, including a laptop and other portable computers, multiprocessor systems, networked computers, mainframe computers, hand-held computers, personal data assistants (PDAs), and on devices that include a processor, a memory, and a display. An exemplary computing system 21 that is suitable for implementing the present invention includes a processing unit 25 that is functionally coupled to an input device 23, and an output device 37, e.g., a display. Processing unit 25 includes a central processing unit (CPU 27) that executes machine instructions comprising an offer management tool and the machine instructions for implementing the menu functions that are described herein. Those of ordinary skill in the art will recognize that CPUs suitable for this purpose are available from Intel Corporation, AMD Corporation, Motorola Corporation, and other sources.

Also included in processing unit 25 are a random access memory 29 (RAM) and non-volatile memory 31, which typically includes read only memory (ROM) and some form of memory storage, such as a hard drive, optical drive, etc. These memory devices are bi-directionally coupled to CPU 27. Such storage devices are well known in the art. Machine instructions and data are temporarily loaded into RAM 29 from non-volatile memory 31. Included among the stored data is the offer management tool code, operating system software, and ancillary software. While not separately shown, it should be understood that a power supply is required to provide the electrical power needed to energize computing system 21.

Computing system 21 includes a network connection 33, such as a modem, and optional speakers 35. While speakers are not strictly required in a functional computing system, their inclusion enhances the utility of computing system 21 in connection with implementing some of the features of the present invention. As shown, network connection 33 and optional speakers 35 are components that are internal to processing unit 25. However, such units can be, and often are, provided as external peripheral devices.

Input device 23 can be any device or mechanism that allows input into the operating environment. This includes, but is not limited to a mouse, keyboard, microphone, modem, pointing, or other device as described above. Output device 37 generally includes any device that produces output information, but will most typically comprise a monitor or computer display designed for human perception of output. The conventional computer keyboard and computer display of the preferred embodiments should be considered as exemplary, rather than as limiting on the scope of the present invention.

Basic elements of the present invention, a software tool enabling the placement and management of online offers using a single integrated offer management tool, having been discussed above, additional elements of a preferred System will now be discussed. While such additional elements are expected to enhance the usefulness of such an integrated offer management tool, simple software tools based on the above-described basic elements will still be useful. It should be understood that in the following section, all references to dynamic nodes refer to intelligent dynamic nodes, i.e. dynamic nodes with dimensional (x, y, and z) intelligence.

Expanded Functionality of the System

Substantial additional functionality, beyond that in the simplified embodiment discussed above, is provided in the System. Indeed, the System is a comprehensive incentive merchandising software platform that runs on a computer server employed to host the System's online application and database. The System integrates with a sponsor's e-commerce, sales, and marketing infrastructure through a multitude of programmable, interactive links.

The System supports separating master administration into the following roles: technical administration, financial administration, marketing administration, and merchandising administration. Individuals, groups, and/or subgroups in restricted roles or with complete control over master administration may perform the sponsor's administration functions. Preferably, the System allows individuals, groups, and/or subgroups to assume one or more roles according to corresponding organizational responsibilities and/or competencies, which may or may not overlap.

One or more technical administrator(s), likely skilled in computer science and/or networking, may assume responsibility for infrastructure configuration and maintenance, general platform configuration, and the declaration of global variables. One or more financial administrator(s) may assume responsibility for configuring global commerce, currency, tax, surcharge and fee structures, terms, conditions, and standards. One or more marketing administrator(s) may assume responsibility for structuring, categorizing, and packaging global products/services/plans, which are preferably offered to System operators and/or members through commercial purchasing options and/or internally rationed organizational purchase analogies. One or more merchandising administrator(s) may assume responsibility for managing the System's ongoing operation and content approval, regulating internal and/or external sponsor/partner administrator, operator and member System usage, coordinating product/service/plan orders and exchanges, setting distribution and syndication requirements, as well as determining default plans and interface settings.

One or more operator administrator(s) may assume responsibility for project creation, distribution, management, organization, and oversight. Preferably, access at the operator administration level is significantly separate from higher administrative levels (i.e., operators versus administrators) insofar as operator responsibilities are limited to content management, unless System management is explicitly delegated, partially or completely, from merchandising administration.

Lastly, users who become members at any level may be required to maintain accounts with privileges corresponding to the membership level, facilitating consistent, ongoing engagement with System content and features. In all cases outlined above, merchandising administrator(s) preferably control account structure, access, levels, privileges, and any combinations or delegations thereof.

System access for administrators, operators, and members is preferably restricted and tracked using known security procedures, such as log-in mediated by usernames and passwords. Thus, control over System server(s) may be secured by log-in through networked client computing devices connected to the sponsor's network or to the Internet. Preferably, users and members access the dynamic incentives generated by the System utilizing a variety of electronic client devices without having to log-in; users who opt to become members gain enhance features through sponsor-defined membership levels, which may require log-in. Interaction channels enable users to communicate and exchange data and/or currency with the sponsor, partner(s), and/or other users. Preferably, such user interactions constitute sales leads, which are automatically delivered to the sponsor and/or partner(s) in accord with contact points and methodologies specified by the operator for each ad, offer, or catalog. In a preferred embodiment of the present invention, the System incorporates complete data capture and activity monitoring, allowing administrators and/or operators to access internal, System-generated and/or external, System-mediated customizable reports, analyses, and alerts reflecting online user interaction and engagement. Preferably, administrators access additional System-generated and/or System-mediated customizable, real-time reports, analyses, and alerts reflecting online administrator and operator interaction and engagement.

The System preferably enables operators to generate, organize, manage, distribute, and/or display electronically accessed incentive merchandising content. Operators may generate incentive merchandising ads, offers, and catalogs automatically optimized for display on heterogeneous devices, form factors, and access points utilizing forms, themes, templates, design elements (e.g., icons, and images), previews, and wizards. Preferably accessed through global toolbars, operators utilize automated functions of the System to organize, schedule, manage, and monitor complex incentive merchandising projects comprising ads, offers, catalogs, and campaigns. Most preferably, operators may view, add, edit, and/or delete projects; establish filters as well as terms and conditions for user access to projects and project elements; and activate, deactivate, share, and/or protect projects within a secure, coordinated, collaborative work environment. After activation and approval, ads, offers, and catalogs may be distributed to sponsor or partner access points as part of sponsor-defined, System-generated syndication networks. Project completion may be followed by subsequent revision(s) as operators react to reports, analyses, and alerts concerning user behavior, over time.

As content receivers, sponsors may pay or be paid to host System-generated user content on System-generated portals and/or other access points controlled by the sponsor. Conversely, as content providers, sponsors may pay or be paid to send System-generated user content to other sponsor and/or partner access points. Preferably, these inbound and/or outbound distribution arrangements, which may be allocated and/or rationed through product/service/plan packages, may be extended into transaction-based, metered syndication exchanges.

In the System, projects hierarchically relate to each other. Projects, preferably comprising ads, offers, catalogs, and campaigns, may be organized in sets and stored in online directories according to the sponsor's business logic, facilitating granular administrative control. Project sets may be organized in many ways. For instance, projects may be filtered, grouped, searched, sorted, and/or summarized by division, department, product, access point, and/or category. Projects may be further organized within project sets. For instance, projects within a project set may be filtered, grouped, searched, sorted, and/or summarized by event, geographical region, time zone, page location, and/or category/subcategory. Preferably, by default, projects may be organized by project type, such that ads, offers, catalogs and campaigns may each be filtered, grouped, searched, sorted, and/or summarized.

In a preferred embodiment of the present invention, ads and catalogs, which are secondary project types, and campaigns, which is a tertiary project type, support the successful distribution of each offer, which is the primary project type. As noted above, offers promote products and services that are correlated with offers. In turn, ads promote offers and/or products and services correlated with offers. Catalogs group ads and/or offers according to the sponsor's business logic for organized display to users. Further, campaigns preferably group ads, offers, and catalogs into a primary project set according to the sponsor's business logic to provide operators and administrators with organized control over primary and secondary project types. Thus, projects must be placed in a campaign (i.e., one mandatory primary project set, facilitating granular administrative control), and may be placed in one or more optional (i.e., secondary matching group discrimination criteria) project set(s)/subset(s), allowing flexible reports, analyses, and alerts. Placement of a campaign in a project set that is defined as its primary project set may be altered. Thus, a campaign's existing (e.g., default) primary project set may be changed to another eligible, defined project set, if allowed by administrative-level System rules. Automated and manual changes to project status settings (i.e., publish mode of either active or inactive and/or workflow category such as: normal, critical, to schedule, in process, on hold, revising, planning, and ideas) can cascade over project sets and/or project subsets.

The System displays relevant status information for any project in a preferred embodiment of the present invention. Operators generally control projects, in a process supervised by sponsor-assigned administrators. As operators manipulate projects, a System-generated profile is recorded and displayed in the form of project properties to assist operators and administrators with tracking projects or groups of projects through time. Properties may be displayed in reports for groups of projects and/or tabs for each project. For instance, each project may manifest a first tab displaying general information comprising: a project title; titles of forms, themes, and templates drawn upon by the project; the project type; the campaign (i.e., primary project set); and the size (e.g., in kilobytes) of the entire project upon full online display of all project elements. A second tab may display summary information comprising: creation date; original creator; last date modified; last modifier; and special instructions, comments or notes. A third tab may display workgroup information comprising: workflow category; the assigned operator; operator group and/or operator subgroup responsible for the project; review status; and publish mode.

The System preferably incorporates a default range of offer types with corresponding, preformatted offer templates and has a default range of offer types and preformatted offer templates, which operators can call up from System directories and libraries, populate, and submit for approved display to System users. Preferably, an offer type is defined and processed by the System as an online functional analogy mapped from offline correlates (e.g., an online, enhanced, interactive version of an offline coupon) that may have one or more recommended, correlated offer templates (e.g., online display formats that resemble offline coupons in appearance). Offer types may be mapped to a variety of offer templates, which allow for novel and unique combinations of function with form/design (e.g., combining coupon-like functionality with a sweepstakes-like template).

Each offer type (i.e., coupon, sale, etc.) can be dynamically configured with a variety of functional options in unique, novel combinations, such as incentive types (i.e., percentage off, amount off, etc.) combined with expiration parameters (i.e., date versus quantity of online redemptions, whichever comes first), for different offers, depending on the nature, context, and intent of the incentive merchandising approach. Furthermore, offer template defaults, such as image sizes and placements, can be customized by operators and administrators. The System encourages and supports open customization, as operators, administrators, programmers or third-party developers can create, store, and access templates tailored for specific organizational or industry requirements and/or general add-in use within the System.

Preferably in the System, each offer, offer type, and offer template may incorporate one or more System-generated and/or System-mediated channels, facilitating one-on-one, one-on-many, and/or many-on-many interaction. Serving as asynchronous bridges between and among users, sponsors and/or partners, interaction channels facilitate the delivery of leads and sales to sponsors and/or their partners. Each offer may be configured by operators with interaction channels, which enable one-time or ongoing contacts and relationships with users. System operators select interaction channels, which are most likely to encourage commercial interactions and facilitate offline and/or online user purchases from sponsor and/or partners. Preferably, interaction channels may be applied to sponsor-defined project types and/or decoupled for use with related ads and catalogs, which may then promote the offer from which the channel was decoupled.

Preferred methodologies for implementing interaction channels include channels that may be thematically grouped according to their functional similarity and/or intended result, such a: a shop by net interface grouping ActivePurchase, ActiveMailRetum, ActiveProfileTrade, and/or ActiveOrderPlace functions, all of which may be built to support e-commerce transactions in order to facilitate and/or encourage sales activity; or a shop by phone interface grouping ActiveCallOnline, ActiveCallReturn, ActiveCallReferral, and/or ActiveCallResponse functions, all of which may be built to support telephone communications in order to facilitate and/or encourage sales leads.

Using the System, an offer may be created and edited by an operator, approved by an administrator, then distributed for viewing by users. As shown, System-generated banner ad(s) and/or links to related projects may appear near the offer, as specified at edit. The ad may be linked to other System content, such as ads, offers, catalogs, or project elements (e.g., a distinct interaction channel), as specified at edit. In such an instance, preferably by default, related offers may appear as specified by the operator whereas rotating, yet related, ads may appear as specified the System, constituting dynamic presentations and combinations that are consistent with the nature, context, and intent of the sponsor's overall incentive merchandising approach.

An operator might populate a sponsor's, or its partner's access point, which might be a Web page with integrated ads and offers. Projects may be integrated with each access point, according the display characteristics and limitations of each access point, through the placement of code within certain coordinates of each access point. Preferably, using images of various sizes, the code may control the content slots according to operator settings such that System content collapses (e.g., seems to disappear as a larger image is replaced with a smaller image that is barely discernable and/or transparent), or default/generic content appears in its place, when no System content is scheduled to appear on the access point at a given time.

Preferably, ads, offers, and catalogs may also display by default within the System portal, a centralized destination that aggregates and organizes all System content into searchable categories without access point integration. Furthermore, System portal links, encompassing ads, offers, and catalogs as well as dynamic search results, groupings, and/or series may be extracted and posted ad hoc on any access point by operators, facilitating content distribution without having to explicitly declare the destination.

The System provides operators with integrated project tools (i.e., special-purpose editors and designers) to help operators create projects, including an HTML editor, a graphic designer, and a designer for forms, themes, templates, design elements (e.g., icons, images), previews, and wizards. Preferably, the System not only provides defaults, but also enables operators and administrators to create, edit, store, organize, and share their own forms, themes, templates, design elements, previews, and wizards within a library using project tools. The System encourages and supports open customization, as operators, administrators, programmers, or third-party developers can create, store, and access forms, themes, templates, design elements, previews, and wizards tailored for specific organizational or industry requirements and/or general add-in use within the System.

Offers produced by the System can be displayed on various devices, using various form factors and access points. The System may provide previews, templates, themes, and wizards that help operators adapt offer text (i.e., truncated offer text introduction with a basic call-to-action), System interaction channel(s) (i.e., device-specific response channels), and/or graphics (i.e., images scaled, reformatted, transferred, separated, hidden, or deleted) for optimal distribution and display over heterogeneous devices, using various form factors and access points (i.e., Web sites, interactive presentations, text-only portals/sites, voice portals/sites). Device, form factor, and access point specifications such as display, storage, bandwidth, and availability capabilities may be mapped against System content properties, with marketing administrator(s) determining defaults for if/how System content may be adapted (e.g., truncated, prioritized) in accord with product/service/plan characteristics (e.g., only premium plans may permit adapted content).

Using the System, a catalog may be created and edited by an operator, approved by an administrator, then distributed for viewing and sorting by users. System-generated ads and offers may be displayed in listed table format featuring customizable color and/or graphic design schema for pages, table and cell backgrounds, borders, and text. Offer elements, such as distinct interaction channels, may be decoupled and inserted into and/or linked from a catalog. Each row entry is dynamically inserted for display to users after operators or administrators add to the catalog presentation and the catalog is approved for publication. Operators and administrators can customize the System's default page layout, sort order, design, introductory text, column quantity, column headings, and/or table key according to business requirements, industry standards, and/or display context. In this embodiment, default System catalogs include the “Featured” Items Catalog, with a page list layout designed to be populated with ads and/or offers for related items from one or more merchant(s), as well as the “Mall” Merchants Catalog, with a page list layout designed to be populated with ads and/or offers for items offered through several merchants, who may or may not be partners, from a System perspective.

The System includes a toolbar for operators and administrators which is accessed through an Internet browser. Each toolbar menu and submenu contains command(s) which, when activated by a mouse action, invoke function(s) and/or feature(s), and/or direct operators and administrators to points of interest (e.g., a chat room for System operators). The topics, design, layout, colors, titles, subtitles, configuration, uent operators and administrators. For instance, icon(s) may accompany many command lines to provide operators and administrators with quick visual references to frequently used functions, or the toolbar may be complemented by keyboard shortcuts or voice commands.

The System enables operators to navigate through areas, views/perspectives, reports/analyses, and capabilities that are contextually filtered relative to a specific project. A separate window appears next to the relevant project, displaying icons that, when activated by a mouse action, provide views (e.g., folders, reports, and tasks), application and tool shortcuts (e.g., editors and designers), project shortcuts (e.g., graphics, forms, themes, and templates), and other useful shortcuts (e.g., workflow, assignment, review, and published status), all filtered to invoke populated function states and/or display information specifically related to the project in focus. Since administrators are able to access multiple projects, owned by several operators, they can adjust and filter ranges to drill down to specific projects, multiple projects, as well as System-default and sponsor-defined project groupings. Furthermore, views may be filtered and/or restricted by sponsors and/or administrators such that operators have restricted access to certain areas, views/perspectives, reports/analyses, and capabilities.

Operators may conveniently organize and access projects in the System. Projects are hierarchically filtered, grouped, searched, sorted, and summarized by campaign into ads versus offers and catalogs, all of which are stored online as distinct digital files and/or logically grouped elements in directories at lower levels. Sponsors may utilize the System's default campaign-centered schema or may specify their own schema for organizing projects based on project attributes and characteristics (e.g., time/date-centered), since the underlying files and/or logically grouped elements are dynamically associated through the System database. Similarly, System administrators can globally view and access projects from multiple operators and operator groups/subgroups, with the ability to customize the organizational schema. Preferably, projects are accessed through a folder list and/or project access menu interface triggered by, for instance, navigating to FILE>OPEN or FILE>RECENT PROJECTS. Administrators and/or operators can then select projects to view, add, edit, or delete.

The System enables merchandising administrators to delegate high-level capabilities and tasks to operators, operator roles, groups and/or subgroups and/or restrict operators, operator roles, groups and/or subgroups to specific default and/or sponsor-defined functional areas, views/perspectives, reports/analyses/alerts and capabilities in order to coordinate collaborative activities. By default, account administration is granted to one operator, with sole access to all functional areas, views/perspectives, reports/analyses/alerts and capabilities. For instance, operator administration may be divided into legal, finance/operations, and marketing roles with tasks in correspondence with organizational departments. Alternatively, operator administration, or a role, may be shared by a group with certain tasks divided into subgroups. Further, since operators, as well as operator roles, groups and subgroups, may be internal and/or external (i.e., partners) to the sponsor organization, merchandising administrators may delegate and/or restrict based on internal versus external status. Thus, merchandising administrators can mix-and-match System defaults for existing roles, create new roles, and specify the range of capabilities and tasks that may be delegated from administrators to operators.

Operators can schedule projects to automatically appear one time or repeatedly, for an uninterrupted period of time or intermittently. Events that can trigger changes in project status settings (e.g., from active to inactive), include: the occurrence of specific years, months, weeks, days, dates, times, day parts, quantity of impressions, quantity of clicks, quantity of e-mail responses, quantity of online purchases, and/or other criteria that can be extracted from Internet data storage, processing, transfer and/or display events. Changes to project status settings can cascade over project sets and/or project subsets. These time and date parameters can be set to trigger Boolean (i.e., publish mode of either active or inactive) and/or multivariate (i.e., workflow category such as: normal, critical, to schedule, in process, on hold, revising, planning, ideas) settings. Different parameters can be set to simultaneously apply to the same project, triggering in accord with the parameter limit that is first reached, and/or other sponsored-defined criteria and/or priorities. Automatic settings can be manually cancelled, overridden or adjusted by operators and administrators. For instance, after activating the schedule using the toolbar (e.g., triggered by navigating to PROJECT>ACTIVATE AND EXPIRE) operators may schedule projects to appear one time or repeatedly on an hourly, daily, weekly, monthly, and/or yearly basis.

The System enables mediated arrangements, multiple sponsors, each with affiliated/internal and/or unaffiliated/external partner access points, who may display projects on each other's access points as Content Receivers and/or Content Providers. Sponsors may utilize Inbound and/or Outbound distribution based upon contextually-appropriate, sponsor-defined commercial arrangements between the participating parties. Thus, sponsors may act simultaneously as content receivers and content providers. Preferably, relationships between sharing sponsors and partners may be distributed, sorted, filtered, or viewed by: geography/location, product categories/types, service categories/types, delivery terms (e.g., timeliness, coverage), order volume (e.g., quantity), price (e.g., ranges, currencies, rates), quality (e.g., standards, ratings, specifications), reliability (e.g., standards, ratings, history), or sponsored-defined criteria.

Distribution arrangements may be allocated and/or rationed through product/service/plan packages, which allow content receivers and/or content providers to negotiate and set their content display price then bill the counteracting content receivers/providers for any amount owing. Preferably, receivers and providers may select from a variety of common or mutually agreeable payment methodologies, such as invoice, credit card, debit card, electronic funds transfer, pay by check, script, points, or cashless exchanges. System transaction records may be directly transferred into e-commerce, accounting and inventory infrastructure controlled by content receivers and/or content providers.

The System enables different user access levels and benefits. In order to reward and retain loyal users, sponsors may use the System to create voluntary and/or compulsory levels of qualified membership. Preferably, by default the System provides five levels of membership, with each level providing additional benefits and/or capabilities. The System may be designed to provide users with enhanced, personalized rewards in return for volunteering more specific personal and/or financial information. Preferably, by default the System enables members in more advanced levels to partake of benefits in lower levels; however, the System enables a sponsor to mix, match, partition, and/or otherwise customize benefits and levels. For example, all users may initially be permitted to search, compare, and browse the System portal for offers using all criteria, then move selected content to a session OfferBook; however, the sponsors may change the policy, restricting users from searching for offers by price and requiring users to become a member of the e-mail list before allowing content to be moved to a session OfferBook.

Users may opt to become members, with secure log-in access to an account. As users engage with the System by searching, comparing, and browsing offers as well as clipping offers to session OfferBooks, the System persistently prompts users to sign up as members. Furthermore, prominent prompts emanating from user interaction with the System interface (e.g., clip and shop buttons) and/or process state(s) may explicitly restrict access to compelling member benefits, such as the ability to store OfferBooks for future reference and use of a member profile to efficiently transact with merchants, highlighting the benefits of becoming a member.

Once administrator(s) approve member registrations, the approving and/or senior administrator(s) may secure, confirm, restrict, and/or modify member accounts as well as related parameters, and may review related account activity and results through time. Preferably, members may also modify their membership level(s)/commitment(s) or account information and securely log out of their accounts.

Members are entitled to use enhanced functions, enabling them to store unique collections of active offers, which they clipped spontaneously from the System; receive updates if and when new offers in categories/subcategories they specify are added to the System; save categorized lists of all active offers in the System that match with occasions they specify and/or other personal shopping preferences; and, receive scheduled personal reminder snapshots (e.g., active offers may expire into inactive status, then no longer be available for viewing by users/members) and/or summaries of active offers saved to their categorized lists residing on the System.

Projects are created, edited, activated, scheduled, and approved by operators, under the supervision of administrators (who may assume operator responsibilities). Operators acquire control over new or existing projects after purchasing them, expending non-monetary tender, and/or receiving them from administrators or other operators. Preferably, operators may view and open their projects through navigational and functional views/perspectives guided by project types that are grouped into product/service/plan types with similar attributes and properties (e.g., offer and catalog project types grouped into the ActivePromote product/service/plan type versus ad project type grouped into the ActiveAdvertise product/service/plan Type). After opening a project for edit, operators may use project tools to integrate forms, themes, templates, design elements, previews, and wizards that will enhance the project.

Operators may directly assign and/or recommend location parameters through a product/service/plan type (e.g., ActiveLocate), which facilitates control over precisely where and when project(s) will appear, including the ability to designate access point destination(s), reserve slots on the access point destination(s), and granular time/date scheduling for reserved slots. After configuring a project through one or more relevant product/service/plan types, operators may save the project for future reviews and/or edits (e.g., with publish mode set to “Inactive”), or operators may submit the project for administrative review and publication (e.g., when publish mode is set to “Active”). The reviewing administrator(s) may approve the project as submitted, but has other System-default and sponsor-defined options, including return of the project to the operator for revision. Following administrative approval, the project enters the System's global traffic management engine for distribution and syndication, which ensures display of the project through designated access point(s) to user devices.

System-mediated activity may then be captured, enabling operators to track, monitor and review user/member interaction results (e.g., via data capture by project element(s)) through multiple perspectives and trends (e.g., real-time, over time, and/or through predictive statistical analysis). Reports and analysis may be set to automatically notify operators by alerts, which are sent via pop-ups, and/or e-mail/messaging, facilitating rapid reaction, revision, and refinement of the operators' projects, as well as the operators' overall online/offline merchandising approach.

Operators access the System with secure log-in access to a consolidated, role, group or subgroup account. Referred to in the System by default as the “Internet Marketing Campaign Headquarters,” the operator account enables operators to monitor and control projects. Subject to administrative oversight, operator access to functional areas views/perspectives, reports/analysis/alerts, and capabilities may be restricted and/or filtered according to their role, group and/or subgroup. For instance, an operator internal to the sponsor organization may have access to a consolidated account, whereas as an operator that was recruited or otherwise accepted by the sponsor organization to contribute content on behalf of a partner may have access to a more restricted role account.

Once administrator(s) approve operator registrations, the approving and/or senior administrator(s) may secure, confirm, restrict, and modify operator accounts as well as related parameters, and may review related account activity and results through time. Operators may also modify their membership level(s)/commitment(s) or account information and securely log out of their accounts.

Operators are entitled to use complex functions, enabling them to view, add, edit, and delete projects through navigational and functional views/perspectives guided by project types, which are grouped into product/service/plan types; monitor user interaction and engagement through reports/analysis/alerts according to customizable identity, type, level, interface, interface element, process, state, method, time, and/or frequency data capture parameters; invoke project tools that facilitate rapid, enhanced project development as well as contributions/access to shared project elements and corresponding libraries; and, acquire control over new or existing projects after purchasing them, expending non-monetary tender, and/or receiving them from administrators or other operators.

Operators acquire control over new or existing projects by purchasing them, expending non-monetary tender, and/or receiving them from administrators or other operators. Referred to in the System by default as “Add To Campaign,” the project acquisition process enables operators to procure dynamic node and/or portal space, which may be apportioned into discrete time and/or quantity allotments by product/service/plan, from a sponsor, or sponsor's partner. Subject to administrative oversight, the manner and degree to which operators acquire projects may be restricted and/or filtered according to their role, group and/or subgroup. For instance, an operator internal to the sponsor organization may be allotted points (e.g., prorated in proportion to departmental overhead versus System cost) to procure space, whereas as an operator that was recruited or otherwise accepted by the sponsor organization to contribute content on behalf of a partner may be required to purchase space.

Grouped into product/service/plan types (e.g., ActiveAdvertise, ActivePromote, ActiveLocate), preferably products/services/plans (i.e., plans) consist of distinct, complementary combinations of System-derived products and/or services with System-mediated functionality. Preferably, the allotment process may be channeled through a series of online shopping states that rotate through intermediate shopping selection until terminated by check out, which advances operators into purchase and/or non-monetary, proxy purchase. Administrators may establish restrictions (e.g., credit limits or other allotment caps) on purchases and/or proxy purchases globally; by role, group and/or subgroup; and/or, by account. Furthermore, with the same degree of granular control over constituent scope, administrators may specify manual order authorization, set automatic System-mediated authorization criteria, and/or defer to external e-commerce authorization protocol(s).

Delimiting plan metric(s) for space allocation may be determined by administrators. Preferably, delimiting metric(s) may be interlaced to execute hybrid project and plan expiration modes. For example, by default, the System demarcates expiration for location-mediated plans by interactive performance, time, as well as display termination points. In turn, project display allotments and/or entire plans may expire by one or more of these expiration modes.

The System enables operators to view, add, edit, and delete projects through navigational and functional views/perspectives guided by the project Type, which are grouped into the corresponding product/service/plan type (e.g., ActivePromote or ActiveLocate). The distinct plans within the type (i.e., Regional Plan as a distinct ActivePromote plan) provide a framework for defining project history (e.g., plan, order number, sale/point total, and expiration parameters) and attributes (e.g., project ID and project type). Thus, the System may track each project, allowing operators to monitor user interaction and engagement through reports/analysis/alerts according to customizable identity, type, level, interface, interface element, process, state, method, time, and/or frequency data capture parameters. In turn, project dependencies on shared project elements and corresponding libraries may be consistently enforced by the System.

Grouped into campaigns, with declared associations to other projects (i.e., via primary project set, project set(s), project subset(s)), projects may be manipulated within explicit expiration parameters (i.e., with status reported to the operator an ongoing basis), regulated by initial, intermediate, and terminal feature availability. The System further enables operators to view and edit ad projects through a control panel. Operators may execute entry and edit functions related to images, destinations, positions, and reference notes. Preferably, access to control functions may be made available for use by operators to the degree permitted by the corresponding plan environment. For instance, a plan permitting comprehensive placement of ads may not display the function that controls the targeted positioning of the ads in correspondence with page location parameters declared through the System, whereas a plan permitting targeted placement of ads may include such control.

Operators similarly view and edit design elements of offer projects through a control panel. Operators may execute entry and edit functions that, for each offer, control activation variables for templates and types as well as aesthetic variables for corresponding multimedia and graphic presentations.

Preferably, offers may be activated, reactivated, and deactivated by operators on a manual or automatic basis according to time and/or frequency parameters. In turn, reports and analysis pertaining to each offer may be set to automatically notify operators by alerts, which are sent via pop-ups and/or e-mail/messaging. Offer types and templates, as applied to each offer, may also be customized by inserting borders, text, images, graphics, buttons, audio, video or animation. Depending upon the type of presentation, the System enables modification of corresponding style variables, including color, size, thickness, justification, location, font, duration, or volume, as integrated with each offer.

Operators may save activation, aesthetic, and/or functional user interface customizations and contributions to libraries. The libraries containing their customizations to offer types and templates, as well as other offer elements (e.g., fully functional, stand-alone interface buttons), may be shared with other operators. Defaults, such as initial border color, text size, font and volume are predefined by the System and ultimately (re)defined by administrators unless delegated to operators.

Operators view and edit content-oriented CLIP interface elements of offer projects through a control panel in a preferred embodiment of the present invention. Operators may execute entry and edit functions that, for each offer, control activation variables for VIEW and PRINT interface elements. Utilizing project tools, operators control the labeling, aesthetic design (e.g., button color, font size), display mode (e.g., text link instead of buttons), relative position, and optional appearance of CLIP, VIEW, and/or PRINT interface elements, based upon the operator's merchandising criteria/intent and/or the type of device the user is expected to utilize when accessing the offer. Preferably, interface elements not employed or populated either do not appear in the user interface or may be configured to display in a different shade/color/form (e.g., faded, grayed, or shaded to indicate that they are inert) and without activation links.

Configuration for the content portion of the user interface is preferably structured as follows: CLIP controls transfer truncated and/or otherwise summarized information from the corresponding offer to an OfferBook, prompting user who are members to save session OfferBooks to their account; CLIP by VIEW Controls optimize offer content for writing details without printing and/or low-end, limited-display devices (i.e., excluding graphics and text not required for redemption); CLIP by PRINT controls optimize offer content for printing and/or high-end, limited-display devices (i.e., excluding graphics not required for redemption).

The System assures that offer ID, incentive type, category/subcategory, and target region parameters may not be changed once established (default terminal configuration), unless permitted by administrators (e.g., once an offer project is designated as a coupon it cannot be converted to a gift certificate). By default, company name is taken from the operator profile and, if permitted by administrators, may be edited to match the contents of each offer to optimize search performance. These default System settings, and other defaults such as initial image names, image slots, relative image positioning, and permitted image sizes, are predefined by the System and ultimately (re)defined by administrators unless that task is delegated to operators.

Operators view and edit interaction-oriented SHOP interface elements of offer projects through a control panel in a preferred embodiment of the present invention. Operators may execute entry and edit functions that, for each offer, control activation variables for NET and PHONE interface elements. Utilizing project tools, operators control the labeling, aesthetic design (e.g., button color, font size), display mode (e.g., text link instead of buttons), relative position, and optional appearance of SHOP, NET, and/or PHONE interface elements based upon the operator's merchandising criteria/intent and/or the type of device the user is expected to utilize when activating the offer. Preferably, interface elements not employed or populated either do not appear in the user interface or may be configured to display in a different shade/color/form (e.g., faded, grayed, or shaded to indicate that they are inert) and without activation links.

Configuration for the interaction portion of the user interface is preferably structured as follows: SHOP controls assist/guide operators by facilitating technology connections (e.g., direct e-commerce, e-conferencing, member profile, and/or shopping cart links) with sponsor/partner organizational resources (e.g., automated fulfillment and/or customer service personnel) that are equipped to receive and respond to user responses (i.e., sales); SHOP by NET controls assist/guide operators by facilitating technology connections. (e.g., e-mail and/or link address entry slots) with sponsor/partner organizational resources (e.g., fulfillment or customer service personnel) that are equipped to receive and respond to user responses (i.e., leads, sales); SHOP by PHONE controls assist/guide operators by facilitating technology connections (e.g., phone number, e-mail and/or link address entry slots) with sponsor/partner organizational resources (e.g., fulfillment or customer service personnel) that are equipped to receive and respond to user responses (i.e., leads, sales).

Operators recommend, configure, manage, and monitor projects with respect to dynamic node coordinate positions distributed on heterogeneous, declared sponsor/partner access points. Operators and/or administrators view, add, edit, delete, filter, group, search, sort, summarize, and approve/disapprove inbound as well as outbound projects by default, preset, or manual coordination and scheduling criteria, stored in the System's global traffic management engine for distribution and syndication. Subject to administrative oversight, the manner and degree to which operators control project distribution and syndication may be restricted and/or filtered according to their role, group and/or subgroup. For instance, operators whose role is limited to content receiver may only have access to areas, views/perspectives, reports/analysis, and capabilities related to disabling or filtering incoming projects.

In the System, functional areas, views/perspectives, reports/analysis/alerts and capabilities related to distribution and syndication may be may be logically organized according to geographical specifiers such as zip/postal codes, cities/municipalities, states/provinces, countries and/or sponsor-defined parameters (i.e., according to franchise type or department) based on business requirements and/or industry standards. In turn, operators may declare (e.g., enter and/or import) access point attributes (e.g., names, online addresses, quantity of page coordinates), assign slots reserved for System content on the access points, then schedule such System content to appear within reserved slots, with manual or automated oversight and approval by administrators. Further, page span definitions may be assigned within project types to insure adequate space for a given project to appear. For instance, an ad frame may be defined to span two dynamic nodes; consequently the System sends alerts and/or automatically disallows the attempt when an operator violates this rule by placing an offer on the same row as an ad frame within an access point limited to two horizontal dynamic nodes.

Dynamic nodes are preferably defined and verified (i.e., compared against declarations and assignments), then monitored and tracked by markers (e.g., by the insertion of uniquely designated *.GIFs (i.e., image files) and/or transparently positioned *.GIF markers with accompanying source code, and/or other tracking methods) disposed within the access point's source code. On an ongoing basis, according to operator and/or administrative settings (i.e., also triggered by a threshold of failed content distribution attempts), System robot(s)/agent(s) may visit/ping access point(s) to verify that declarations and assignments are available (i.e., running and ready to receive content), intact (i.e., not moved or otherwise altered), and identical to settings accepted into the database. The System may then, according to operator and/or administrative settings, notify/alert/warn dynamic node owners if the status of dynamic nodes differs from database settings (i.e., if schedules and/or content refresh intervals are rendered irrelevant by access point downtime). For instance, an operator for a content receiver may be alerted by pop-up upon log-in and/or e-mail/messaging, that one of their five declared Web pages and two of their ten assigned dynamic nodes have not been available to receive System content for the last twelve hours.

Since access points may significantly differ in terms of the cumulative amount of content that the targeted form factor display(s) and/or service(s)/carrier(s) can effectively support, the System may recommend the quantity of dynamic nodes, and optimize/truncate System content for declared access points according to device limitations. At the lower end, many devices manifest physical constraints limiting dynamic node placement to one; conversely, while there is no System-imposed upper limit on the quantity of dynamic nodes for a particular technology, device display, or form factor, skilled practitioners will clearly recognize real and/or practical limitations in the number of dynamic nodes that are provided on a device with a limited display area.

Furthermore, since dynamic nodes within the access point's source code are permanent until replaced, the System preferably requires corresponding default System content inputs for placement on access points when no System content is scheduled to appear. Otherwise, by default in such cases, the System enforces System content that collapses (e.g., seems to disappear as a larger image is replaced with a smaller image that is barely discernable and/or transparent).

Operators may configure, define, assign, coordinate and track transactions related to ad and/or offer projects appearing on specified internal and/or external (i.e., partner or third party sponsor) access points delimited by one- and/or two-way peer exchange rates (i.e., by financial and/or points values) between access points that send certain types of user traffic (e.g., categorized by unique visits, repeat visits, length of visit, breadth of visit, System-defined, and/or sponsor-defined) versus access points that receive certain types of user traffic.

Dynamic node position quality refers to the degree to which distinct System content in that dynamic node is likely to appear and be consumed during a user visit (e.g., near the top left of the access point with few projects). Dynamic node position quantity refers to the number of dynamic nodes reserved to appear, which increases the probability that aggregate System content will appear and be consumed (i.e., be accessed) during a user visit (e.g., by placing the content in multiple slots within the access point). Preferably, using System variables, administrators and operators may also define their own content ratings (e.g., beyond and/or by redefining dynamic node position quality) in order to facilitate the valuation and exchange process. Exchange prices can also be differentiated by partner, volume, etc.

Page declarations and page assignments (reserved slots) may not be changed once established (default terminal configuration) and then approved to receive System content. In turn, subsequent to entry of an access point and its dynamic nodes for exchange, the details may not be changed once established (by a default terminal configuration). Preferably, such changes require resubmission for administrative approval.

Administrators access the System, with secure log-in access to a consolidated, role, group or subgroup account. Referred to in the System by default as the “Master Administration,” the consolidated administration account is initially granted to one administrator, with sole access to all functional areas, views/perspectives, reports/analysis/alerts and capabilities. Generally, master administration extends control over: products/services/plans and categories; sponsor/partner administrators, operators and members; products/service/plan orders and exchanges; and System administration.

Master administration may be split into to four primary administrator roles, each with distinct capabilities: technical, financial, marketing, and merchandising. Technical administrators have access to capabilities allowing initial System configuration as well as integration with the sponsor's technology infrastructure. Financial administrators have access to capabilities allowing them to control rates, terms, conditions, and standards for transactions and exchanges between sponsors, operators and users/members. Marketing administrators have access to capabilities allowing them to assemble and package product/service/plan combinations for consumption by operators and users/members. Merchandising administrators supervise most critical daily System tasks and responsibilities, most of which involve determining, monitoring and accessing all System accounts and capabilities. By default, all administrators may view (i.e., not add, edit, or delete) all functional areas, views/perspectives, reports/analysis/alerts and capabilities available to merchandising administrators, unless completely or partially restricted from doing so. Technical administrators accomplish infrastructure configuration, System platform configuration, and global variable declarations.

The System may be hosted stand alone and/or jointly on/with the sponsor's other high-end servers, and is preferably equipped with networked storage. Preferably, the System operates on enterprise-level operating system(s) (e.g., Microsoft Corporation's WINDOWS™ operating system, or one of the Linux operating systems) running SQL-compliant relational database(s) with means to extract and rollback complete daily System image backups without downtime. Preferably, the System operates with enterprise-level Internet (e.g., Web) application server software systems that support real-time database integration (e.g., COLDFUSION™ or enterprise-level JAVA™). Most preferably, the Internet service connection for System server(s) supports always-on, server-grade, bi-directional bandwidth provisioned with load balancing.

System platform configuration requires that technical administrators establish the System's base/root Internet locations and links, thus establishing the System portal location and/or point of distribution origin to be accessed by administrators, operators and users/members. At this stage, the sponsor's inventory, accounting and e-commerce/payment systems (e.g., shopping cart or enterprise resource planning) may be integrated with the System, and access points as well as their dynamic node coordinate positions may be entered/imported. Sponsored-defined integration, import and/or export activities, such as batched data imports/exports and/or other file output (e.g., printed, XML, comma-delimited interchange, ACSII text, or Adobe's ACROBAT™ format) may also be specified. Preferably, the sponsor's registration profile anchors the implementation for tracking the System's lease and/or purchase from the System's licensor.

Global variable declarations allow the technical administrator to establish a title for sponsor's System and determine the System's stylistic theme(s). Preferably, sponsor logos varying in size, color and background may be imported and/or remotely called (e.g., Internet addresses to images). Technical administrators may configure user interface displays to complement the sponsor's organizational style(s)/brand(s) by specifying backgrounds, colors, contrast colors, font faces, text colors, link colors, and VLink colors. Preferably, XML style sheets (e.g., Cascading Style Sheets) may be integrated, imported, and/or remotely called (e.g., by using Internet addresses to Cascading Style Sheets) to partially and/or completely define stylistic theme(s).

Preferably, the final technical configuration stage guides the technical administrator through establishing System defaults. Preconfigured product/service/plan types are made available for customization and entirely new product/service/plan types may be defined. Corresponding default definitions for initial (i.e., available upon open, preferably completed before an initial save), intermediate (i.e., edited on an ongoing basis), and terminal (i.e., final after being initially saved) settings may then be declared for System-mediated functionality available through each product/service/plan type. At this stage, the technical administrator initializes defaults level(s) (i.e., roles, groups and/or subgroups) and degree(s) through which functional areas, views/perspectives, reports/analysis/alerts and capabilities may be accessed by administrators/operators. Most importantly, administrator accounts may be established, and corresponding tasks and responsibilities may then be delegated from the technical administrator to other administrators. Lastly, the technical administrator determines defaults for: project set filters, groups, and sorts (e.g., how projects are initially sorted in reports); project properties available for view (e.g., whether project creation dates may be viewed by operators); and interaction channel availability as well as initial appearance and content (e.g., array pallet as well as button style, array composition, relative position, instructions, and links).

Initialization of a network of dynamic nodes, as well as dynamic nodes that may be added subsequently as needed, is preferably actuated by System-generated robot(s)/agent(s) that: visit the declared access point(s); extract the source code from each access point to System storage; scan the extracted source code for the presence and relative positioning of System code; and compare the permitted coordinate range (e.g., x, y, z, etc. dimensional locations within subdivided display size range for the intended form factor(s)) for each access point as specified within variables in the dynamic node implementation (i.e., System code as placed within the access point) against actual placement within the access point, using the corresponding original dynamic node declaration stored on the System as the auditing frame of reference.

Preferably, if the dynamic node has not yet been placed within the access point or if the dynamic node is not likely to display properly (e.g., due to inadequate space and/or because the dynamic node has been placed in a coordinate location that diverges from the original declaration) when the System robot(s)/agent(s) visits, the System notifies (e.g., via reports, analysis, and/or alerts) corresponding operator(s) and/or administrator(s). The System may generate code (e.g., prototype models of the access point source code, with dynamic node(s) automatically inserted), visual models, previews and/or wizards demonstrating how dynamic nodes display, and/or otherwise recommend and facilitate locating dynamic nodes within each access point.

After initialization and verification of a network of dynamic nodes, the System may poll dynamic nodes and dynamic nodes may exhibit awareness of their location and surrounding content population conditions. For instance, if a project already occupies a dynamic node requested by the project next scheduled to occupy the slot, it may preferably be sent/repositioned to another dynamic node on the access point or rotated into (i.e., entirely replaced with) the project next scheduled to occupy the slot. According to System-default and/or administrator-defined criteria, the System may preferably execute adjustments to each project under certain access point content population conditions during edit or at run-time by: polling dynamic nodes for their coordinate location within an access point relative to other dynamic nodes and/or other access point content; automatically adapting the dynamic node's variables to reposition, resize, zoom, magnify, intensify, and/or otherwise accommodate multidimensional negotiations that minimize spatial/perceptual conflicts; contextually requiring certain user interaction(s) (e.g., mouse-over versus click versus double-click) depending upon one or more of the aforementioned characteristics in order to trigger destination(s); and/or dynamically manifesting and guiding/linking a user to certain destination(s), triggered by user interaction(s), depending upon one or more of the aforementioned characteristics.

Financial administrators manage structures, terms, conditions, and standards for global commerce, currency, taxes, surcharges, transaction fees, and shipping. The System preferably supports online as well as offline transactions such as remotely processed e-commerce (e.g., credit cards, electronic funds transfer (EFT), check/bank draft), step-by-step e-mail/messaging, phone billing, mail/invoice, purchase order/account, and/or sponsor-defined methods (e.g., trade), all confirmed by customizable e-mail/messaging receipts. Preferably, authorization may be set to transpire according to manual, automatic, external protocol, or sponsor-defined criteria. Financial administrators configure their transaction and notification preferences (i.e., corresponding confirmations and receipts) using the configuration toolkit included within the commerce types module. Once configured, fill-in-the-blank forms/prompts request pertinent and necessary information from operators and users at interface process states related to commerce types, taxes, surcharges, transaction fees, shipping, and product/service plan price (i.e., currency, discounts, and allowances).

Exchange rates between disparate currencies may be established by accessing an online Currency Table, or any sponsor-preferred method of calculation. Confirmations and receipts may be set to trigger upon initial, intermediate and/or terminal stages of the transaction process with corresponding e-mail/messaging structure for confirmations and receipts for each stage (e.g., using encrypted messages copied to fulfillment personnel for the final steps of an e-mail transaction).

Taxes may be configured through a Tax Table, which allows taxes to be computed across multiple tax jurisdictions, outputting subtotal(s) to the order profile. Surcharges and alternate rates may be calculated under reserved, open, sponsor-defined table(s), providing flexibility in calculating order profile totals. Transaction fees are based on guidelines, terms, rates, and conditions established within the System's syndication module. The System Transaction Log tracks, reconciles, and tabulates system activity in terms of net transaction fees between System peers, producing contextual subtotal(s). The Shipping Rates Table may be used to calculate relevant transport charges for product(s) and/or service(s) related to System-mediated software orders, expressed as a base plus weight versus count versus product subtotal. The Product/Service/Plan Table allows financial administrators to view, approve or add, edit, and delete financial parameters related to specific products, services, and/or plans (e.g., prices, tax applicability, expiration parameters, discounts/allowances. In this case, financial and marketing administrators may collaborate to determine the degree, composition, and/or formula of acceptable outputs to the order profile, by default, and product/service/plan details and a price minus discount(s) subtotal that are output to the order profile. Finally, the order profile formats and itemizes each subtotal, collates subtotals to produce a grand total with complete order details, executes/forwards the order, and exports invoked variables to confirmations and receipts.

Integration of each dynamic node and/or each project with distinct external inventory, accounting and e-commerce/payment systems (e.g., shopping cart or enterprise resource planning), which depend on the contextual placement and/or point-of-contact within each access point may preferably be specified by operators, if permitted by financial administrator(s). In such instances, financial configuration tasks may be explicitly delegated, partially or completely, from financial administration, enabling operators to replace default System settings for one project or across several projects (i.e., sets, subsets). Preferably, the SHOP by NET interface within Offers serves as the bridge to external inventory, accounting and e-commerce/payment systems. Since overriding the defaults may require the System to transfer content, business logic, and/or semantic data to external processing protocol(s), the System preferably provides flexible outbound data feeds and hooks (e.g., API's, Java, and/or XML code output for export and/or automated transfer) on a case-by-case basis (e.g., filtered, grouped, searched, sorted, and/or summarized by table, multiple variables, variable type, and/or variable).

The System enables marketing administrators to structure, categorize, and package global products/services/plans, which are offered to System operators and/or members through commercial purchasing options and/or internally rationed organizational purchase proxies. Marketing administrators may preferably define product/service/plan types, which are frameworks for associating System-derived benefits with System-mediated benefits (e.g., training combined with projects and space on access points) for consumption by operators. Although operators are the primary audience, users and members may be also be targeted as consumers for products/services/plans (i.e., with limited, delegated capability). System-derived products (such as system on media, device/hardware (e.g., CD, hard drive, ROM), a system in software bundle/package, and a system with platform (e.g., a software/hardware bundle)) may be combined with System-derived services (such as training, consulting, and support, or leasing, hosting, and infrastructure), and System-defined plans.

New product/service/plan types may be formed, and in turn, new product/service/plan amalgams may be added within types. Categories and subcategories within types (i.e., regional and national plans under the ActivePromote plan type) assist operators in comprehending the intent and scope of available products/services/plans. Attributes, which may be determined when each new product/service/plan is created (e.g., product image display at the points-of-purchase/-commitment), feed into the System's market display, where operators shop for products/services/plans after filtering, grouping, searching, sorting, and summarizing purchase options.

Most notably, marketing administrators determine plan types and plans, which logically bundle System components (e.g., projects and forms combined with specific levels of user capability) and are subsequently packaged for acquisition (i.e., purchase and/or purchase proxy) by operators. The Plan initialization process preferably allows marketing administrators to determine elements and aspects of a plan that merit data capture at the user interaction level, which feeds reports, analysis and alerts. For instance, the marketing administrator may decide that, for a given plan, tracking (i.e., capturing data for) project elements is not only relevant but may be packaged and marketed such that only more expensive plans feature granular reporting, analysis, and alerts. On the other hand, mid-level level plans may be structured such that general tracking is allowed by project only; and entry level plans (e.g., teasers) may not allow tracking at all, so that reporting, analysis, and alerts are entirely disabled. Similarly, variations in device profiling capability may be packaged and marketed as a differentiating plan features. Again, in some cases marketing administrators may target users and members; for instance, access to helpful shopping trends across the System may be offered to attract paid members. Furthermore, monitoring/tracking parameters related to purchase of the product/service/plan itself (e.g., a profile of a purchasing operator, order time, order quantity) may be grouped into System-generated reports and analysis that may then be set to automatically notify administrators by alerts, which are sent via pop-ups and/or by e-mail/messaging.

The System further enables merchandising administrators to regulate internal and/or external, sponsor/partner administrator, operator and member System usage, coordinate product/service/plan orders and exchanges, and manage the System's ongoing operation approval. The merchandising administrator preferably manages accounts for administrator, operator, and member roles, groups, and subgroups. Subsequently, System roles, groups, and subgroups are determined by the functional areas, views/perspectives, reports/analysis/alerts and capabilities that an administrator, operator or member is allowed to access. The System enforces and monitors account profile information according to parameters established by the merchandising administrator. Account access and customization privileges are granted by merchandising administrators to varying degrees, ranging from log-in to full account customization to open source code access to the account's building blocks.

In complement, merchandising administrators may view, access, add, import, edit, configure/reconfigure, restrict, and delete accounts, and drill down from encompassing views, perspectives, reports, analyses, and alerts to the individual account, account element, or account variable. For instance, the degree of latitude an operator has in distributing ads and offers may be set such that none, some or all ads and offers require administrative approval before they are eventually activated for distribution. Furthermore, for instance, monitoring/tracking parameters related to account activity (e.g., frequency of log-in or use of a particular theme by a group of operators) may be grouped into System-generated reports and analysis that may then be set to automatically notify merchandising administrators by alerts, which are sent via pop-ups and/or by e-mail/messaging.

Preferably, all orders placed through the System by operators and members are manually or automatically approved through the merchandising administrator unless the responsibility is explicitly delegated, partially or completely, to other accounts and/or account levels. Orders are executed using currency and tax parameters set by the financial administrator unless the merchandising administrator intercedes with translation filters set to convert standard currency into System-mediated tender (e.g., points or transaction exchange credits) at the global, aggregate, account, and/or transaction level(s). Preferably, merchandising and financial administrators may collaborate to determine the degree, composition, and/or formula of acceptable translation outputs for each conversion setting. For instance, orders placed by a particular partner may pass through the order profile with all subtotals filtered/zeroed out with the exception of those originating from the System Transaction Log. Such orders may be tabulated according to non-monetary net point values, which are based on the exchange of user interaction events between two specific access points, expressed, for example, at 10% on the dollar, displayed without dollar signs, and executed at a specific time of the month (i.e., a snapshot of transactions record is taken, transactions are reconciled, and net points are transferred between accounts). Preferably, the merchandising administrator may view, add, edit and delete conversion mode(s) for such exceptions, with approval by the financial administrator. Furthermore, merchandising administrators may partially or completely reverse such exceptions, such that points may be redeemed for currency at a designated or coincidental time.

The System enables merchandising administrators to set distribution and syndication requirements, to determine default plans, to set interface settings, and to manage the System's ongoing content approval. Projects as well as objects, functions and operator roles may be combined to create new, sponsor-defined product/service/plan types by marketing administrators. In turn, merchandising administrators determine which product/service/plan types will serve as System defaults (i.e., automatically available throughout the System). Once approved for default status, the System releases that product/service/plan type's projects for use within the System by operators and/or members, contingent upon the focus (i.e., scope of allowed account levels, features, objects, and projects) of the new type as well as functional design and interface presentation (i.e., integrated add-ins, System functions, objects, process requirements). Enhanced System functionality such as notices and alerts may be incorporated to trigger within the product/service/plan type environment, and convenient content pre-fills and presets help constituent operators and/or members to immediately make use of the product/service/plan. For instance, the ActiveLocate plan type uses access point locations in the form of Internet addresses (i.e., URL's) as its focus. Thus, the account interface will enable the corresponding collections of URL's to be organized through the System's drop-down menus and toolbars with the declared name of the locations and its designated levels (i.e., access point URL's versus dynamic node URL's) serving as reference points for filtering, grouping, searching, sorting, and organizing such projects, as well as corresponding reports, analyses, and alerts. In turn, inputs that enable operators to satisfy process requirements, as opposed to design libraries or search boxes, will appear when an ActiveLocate plan is opened.

Once a product/service/plan type is approved by the merchandising administrator, it's projects, campaigns, primary project sets, project sets, and project subsets may be processed through the System and displayed to users; as a result, corresponding reports, analyses, and alerts (e.g., operator order frequency reports and user interaction reports) are sent to the merchandising administrator, as well as operators, using the product/service/plan type, based upon approved data capture settings. Consequently, as completed projects within the new product/service/plan type are activated and the marketing administrator attempts to make changes to the new plan, requests for approval are sent to the merchandising administrator, and or delegates. Furthermore, monitoring/tracking parameters related to alteration of the product/service/plan (e.g., additions of new plans under a type or curtailment of a plan's feature set) may be grouped into System-generated reports and analysis that may then be set to automatically notify administrators by alerts, which are sent via pop-ups and/or by e-mail/messaging.

Preferably, global categories and subcategories apply to all product/service/plan types, including those that are sponsor-defined. Visual category and subcategory enhancements (e.g., images and brief description) may be activated to assist the user in immediately comprehending the navigational significance of the category. For example, a small picture of household appliances may display in the headers of result sets for user searches, compares, and browses that occur in that category. Most preferably, categories and subcategories may be tailored to specific organizational and/or industry requirements. For instance, a grocery store chain's categories will differ substantially from an auto dealership's categories. Categories and subcategories determined by the merchandising administrator feed into the System's user interface, where users and members interact and shop through chosen offers after filtering, grouping, searching, sorting, and summarizing System content.

In correspondence, the same category/subcategory schema is preferably used by operators in configuring projects for display to users.

The following definitions relate to the above disclosure and the claims that follow. While many of the terms will be familiar to those of ordinary skill in the art, the terms “access points” and “dynamic nodes” bear particular relevance to the present invention, and the observant artisan will review such terms with care.

Definitions of Terms

Access Point: Internetworked, self-contained, discrete block of source code that customarily displays as an element within a larger multidimensional presentation (e.g., HTML page within a Web site; WML card within a wireless Internet deck; or XML document within a digital sign sequence), as it resides in latent form on the server or other point of origin.

ActiveAdvertise (see also, Plan Type): A plan type that describes and executes ad projects through the System.

ActiveCallOnline (see also, Interaction Channel And Shop): An interface containing Internet telephony tools and links that allow users to call immediately, without disconnecting from the Internet, to purchase, place an order, redeem incentives, sign up for membership programs, or ask for more product information.

ActiveCallReferral (see also, Interaction Channel and Shop): An interface containing inputs that allow operators to display phone numbers that correspond with appropriate points of contact, departments, and/or physical locations.

ActiveCallResponse (see also, Interaction Channel And Shop): An interface containing real-time chat, messaging, and/or paging tools and links that enable operators to engage with users in order to purchase, place an order, redeem incentives, sign up for membership programs, or ask for more product information. Users input numbers and/or addresses they can be reached at in order to receive operator response.

ActiveCallReturn (see also, Interaction Channel And Shop): An interface containing callback notes that enable users to purchase, place an order, redeem incentives, sign up for membership programs, or ask for more product information via a return phone call from the operators representatives. The System enables operators to illicit user requests by providing a selection of common requests in a drop-down window for immediate select-and-send by users, tools to build customized drop-down menu request options, and a general comment box for users to generate their own requests.

ActiveLocate (see also, Plan Type): A plan type that describes and executes the distribution and syndication of projects through System-mediated networks of access points controlled by sponsors and their partners.

ActiveMailReturn (see also, Interaction Channel And Shop): An interface containing mail enablers that allow users to purchase, place an order, redeem incentives, sign up for membership programs, or ask for more product information. The System enables operators to illicit user response by providing a selection of common responses in a drop-down window for immediate select-and-send by users, tools to build customized drop-down menu response options, and a general comment box for users to generate their own messages.

ActiveOrderPlace (see also, Interaction Channel And Shop): An interface containing real-time chat, messaging, and/or video tools and links that allow operators or sponsor/partner representatives to converse with users in order to purchase, place an order, redeem incentives, sign up for membership programs, or ask for more product information.

ActiveprofileTrade (see also, Interaction Channel And Shop): An interface containing entertaining, interactive data collectors, such as surveys, questionnaires, contests or games, that transfer detailed geo-demographic information to a sponsor-assigned e-mail address and/or database. This feature enables any operator to offer an additional level of incentive, or more product information, in return for receiving detailed demographic information from self-qualified and/or system-qualified user prospects.

ActivePromote (see also, Plan Type): A plan type that describes and executes offer and catalog projects through the System.

ActivePurchase (see also, Interaction Channel And Shop): An interface containing transaction and purchase links that encourage users to purchase, place an order, redeem incentives, sign up for membership programs, or ask for more product information through any sponsor's e-commerce system.

ActiveSave (see also, Plan Type): A plan type that describes and executes organized presentations of projects for users through the System.

Ad: A default secondary project type that, while mediated through the System, behaves in a manner similar to other Internet or Web advertisements. Ads often link to and/or promote other System projects.

Administrator: A person who is granted a management-level System account with a stored profile, and thus, is able to, individually or with a collaborative group or subgroup, configure global and granular roles, groups, subgroups, rules, policies, procedures, oversight and/or technical support, on behalf of sponsors.

Affinity Group: Business associations, private clubs, non-profit organizations, schools, governments, peer communities, or any other associating groups (in league or not).

Assigned To (see also, Project Property): An automated or manual project status setting that tracks collaborative work authorship/ownership and may cascade over project sets and/or project subsets. The range of settings may include, for instance: operator name, subgroup name, and group name.

Browser: An application that accesses and displays files and other data available on the Internet and other networks.

Call-To-Action (also, Call-For-Action): An inducement to physical or mental response, particularly with regards to a commercial solicitation.

Campaign: A default tertiary project type that serves as the one mandatory primary project set for each project, providing operators and administrators with organized control over primary and secondary project types according to the sponsor's business logic. Placement of a campaign in a project set that is defined as its primary project set may be altered; thus, a campaign's existing (e.g., default) primary project set may be changed to another eligible, defined project set if allowed by administrative-level System rules.

Catalog: A default secondary project type that manifests an aggregate display of ads, offers, other projects, as well as project elements, assembled manually by System operators or automatically by the System in response to content preferences selected by operators or provided by users. Drawing upon interface responses and/or content preferences provided by users, catalogs may be synchronously or asynchronously assembled and disseminated by the System through CLIP, SHOP, search, compare, browse, or other interfaces that facilitate environmental data collection, processing, storage, and display as executed by the System in relation to users.

Category (also, Subcategory): Projects are configured with display categories to help users find System content that interests them. Administrator can define as many categories and subcategories as appropriate for their System, based on business requirements and/or industry standards. Categories are typically divisions, departments or related subjects, such as cruises or tours in the travel business. A subcategory under cruises might be “Caribbean” or “Alaskan”. On display, the (sub)category might also include “Things to Do on Your Cruise,” “Automobile Rentals,” “What to Wear,” or other related topics, links, images, and/or (sub)categories.

Client: A computer or program that can transfer files for manipulation, run applications, and/or request application-based services from a file server over a network.

Clip: An interface containing functions that filter, group, search, sort, or summarize projects for optimal display or output. CLIP serves as the anchor for PRINT (i.e., CLIP by PRINT) and VIEW (i.e., CLIP by VIEW) interfaces, which respectively optimize project display and output for printing and limited-capability viewing.

Content (also, System content): Presentation(s) designed to be displayed for perceptual, sensory consumption (e.g., graphics, audio, video, animation, text, and/or multimedia). The System produces projects, such as ads, offers, and catalogs, which are classified as System content.

Currency: Money, points, credits, rebates, redemptions, certificates, coupons, or any other means of exchange.

Database: A collection of related data, organized for convenient access.

Design Element (also, project design element): An image, icon, or other graphic building block used to embellish a project and optionally configured to trigger links or System functions.

Devices: Client data display and/or processing apparatus (e.g., electronic terminal, thin client, personal computer, mobile phone, portable computer, kiosk, digital sign, computing device, or appliance).

Distribution (see also, Syndication): The state of positioned dynamic nodes and their frequency of occurrence collected from measurements over a statistical population, recognizing the spatial and temporal array of dynamic nodes in relation to events as well as other objects and/or content on an access point. Monitoring and managing this process is critical to effectively marketing and supplying products and services through the System.

Dynamic Node: An area within an access point that is set up to receive System content (e.g. online offers managed by an offer management tool). A dynamic node may be configured such that it: (1) exhibits polymorphism (e.g., object-oriented coding), allowing it to adapt its variables to resize, zoom, magnify, amplify, intensify, and/or otherwise accommodate multidimensional negotiations that minimize spatial/perceptual conflicts; (2) exhibits graphic, audio, video, animation, text, and/or multimedia content; (3) contextually requires certain user interaction(s) (e.g., mouse-over versus click versus double-click) depending upon one or more of the aforementioned characteristics in order to trigger destination(s); and, (4) dynamically manifests and guides/links a user to certain destination(s), triggered by user interaction(s), depending upon one or more of the aforementioned characteristics. A dynamic node may be a client (e.g., applet), a server (e.g., servlet), and/or a peer (e.g., able to poll other dynamic nodes) operating (e.g., repositioning and displaying System content) within and between access point.

Dynamic Node, Intelligent: An area within an access point that is defined according to System coordinate positions, and set up to receive System content. A dynamic node may be configured such that it: (1) inherits and/or encapsulates (e.g., object-oriented coding) awareness of its coordinate location within an access point relative to other dynamic nodes and/or other access point content; (2) exhibits polymorphism (e.g., object-oriented coding), allowing it to adapt its variables to resize, zoom, magnify, amplify, intensify, and/or otherwise accommodate multidimensional negotiations that minimize spatial/perceptual conflicts; (3) exhibits graphic, audio, video, animation, text, and/or multimedia content; (4) contextually requires certain user interaction(s) (e.g., mouse-over versus click versus double-click) depending upon one or more of the aforementioned characteristics in order to trigger destination(s); and, (5) dynamically manifests and guides/links a user to certain destination(s), triggered by user interaction(s), depending upon one or more of the aforementioned characteristics. A Node may be a client (e.g., applet), a server (e.g., servlet), and/or a peer (e.g., able to poll other Nodes) operating (e.g., repositioning and displaying System Content) within and between Access Point.

Dynamic Node Coordinate Position: The dimensional location(s) (e.g., x, y, z, etc.) of the dynamic node within the display area available for an access point (e.g., coordinates x=100 and y=150 on a Web page, specifying Cartesian dimensions; or coordinates x=2 and y=3 on a voice page, where x represents audio length in seconds and y represents audio volume in decibels).

Dynamic Node Position Quality: The degree to which distinct System content in the dynamic node is likely to execute, appear, and/or be perceived/consumed during a user visit given its relative position and other conditions within an access point (e.g., near the top left of a Web page with few other projects and/or little other content; or near the beginning of a voice page).

Dynamic Node Position Quantity: The raw number of dynamic nodes reserved to appear within an access point, which increases the probability that System content, in aggregate, will execute, appear, and/or be perceived/consumed during a user visit (e.g., by being placed in multiple slots within an access point).

Expiration Parameter (see also, Master Schedule): A definable trigger (e.g., variable, function, or object) for terminating or deactivating System content displays.

Form (also, Project Form): A segment of a project, imbued with interlacing designs and/or functions, that may be reused in other projects; may also be an entire template configured with functions and saved as a Form.

Frame: On World Wide Web pages, a frame is a bordered area that acts as an independent browser window. There can be a number of frames within the same page, and they can be separately scrolled, linked, and viewed. Sometimes a frame can be used to view an entirely different Web site without leaving the original site that contains the frame. To view a page that has frames, one must use a Web browser that supports frames.

Functional Configuration (see also, System-Mediated Functionality): Initial (i.e., available upon open, preferably completed before an initial save), intermediate (i.e., edited on an ongoing basis), or terminal (i.e., final after being initially saved) control over System-mediated functionality, which may be used to ration access to System feature sets.

Geographic Levels: Spanning international, national, regional, state, local, and/or city/county levels of relevance.

Group (also, Subgroup): An aggregation of individuals who share a System account manifesting certain functional areas, views/perspectives, reports/analysis/alerts and capabilities with respect to collaborative activities.

GUI (Graphical User Interface): A pictorial representation of computer information, commands, and/or functions on a screen or monitor.

Host: A computer or program that is a repository for services available to other computers over a network.

HTML (Hypertext Markup Language): A markup language used to structure text and multimedia documents and to set up hypertext links between documents, used extensively on the World Wide Web.

HTTP (Hypertext Transfer Protocol): A protocol used to request and transmit files, especially Web pages and Web page components, over the Internet or other computer network. The protocol generally requires an HTTP client program on one end, and an HTTP server program on the other end.

I-Frame: A frame that may diverge from the borders of a World Wide Web page, appearing as a self-contained island within the page, or as a page within a page.

Incentive: Pertaining to a two-way user interaction interface that obtains data and/or returns immediate results or updated information through demonstrations, samples, coupons, auctions, barter sessions, discounts, trials, demos, freebies, prizes, rewards, points, certificates, samples, bonuses, offers, or other enticing promotional content and/or material designed to incite designated user interaction(s).

Incentive Amount: A declared, functional container that supports polymorphism such that it encapsulates and/or inherits (e.g., object-oriented coding) means for quantifying incentives for users (e.g., across currency exchange rates). A quantitative measure customarily designed to encourage user interaction (e.g., degree of percentage reduction, or sum for dollars off).

Incentive Template (see also, Offer Template and Template): An online design analogy mapped from offline correlates (e.g., online display formats that resemble offline coupons in appearance) and bound with a defined incentive amount and/or incentive type.

Incentive Type: A declared, functional container that supports polymorphism such that it encapsulates and/or inherits (e.g., object-oriented coding) means for describing incentives for users (e.g., visually or phonically). A qualitative characterization customarily designed to encourage user interaction (e.g., “percentage reduction,” or “dollars off”).

Interaction Channel (also, Correspondence): Online and/or offline phone/fax in/out/response, chat, messaging, hyperlinks, e-mail in/out/response, locations/maps, phone number referrals/directories/look-ups, video/voice conferencing, and/or other means of communication and/or exchange.

Internetwork: Interconnected combinations of wired, wireless, digital, analog, or other networking technology.

Library (see also, Project Element): An organized collection of objects within the System, such as forms, themes, templates, design elements (e.g., icons, images), previews, and wizards, which facilitates the collaborative origination and management of System content. Libraries may or may not be shared among and between operators and administrators.

Master Schedule: The main System calendar that resolves schedule conflicts for project displays through each dynamic node according to preset sponsor/administrator-defined priorities and/or by alerting operators/administrators for intervention. The calendar regulates events that can trigger changes in project status settings (e.g., from active to inactive), such as: years, months, weeks, days, dates, times, day parts, quantity of impressions, quantity of clicks, quantity of e-mail responses, quantity of online purchases, and/or other criteria that can be extracted from Internet data storage, processing, transfer and/or display events. Different parameters can be set through the calendar to simultaneously apply to the same project, triggering in accord with the parameter limit that is first reached and/or other sponsored-defined criteria and/or priorities.

Member (see also, User): A System user who has registered and obtained a System account with a stored profile, customarily enabling privileged levels of participation not available to unregistered users. A member account is a restricted operator account, customarily limited to receiving System content.

Menu: A list or set of available options on a computer display or other electronic viewing surface.

Merchandising: The planning and promotion of sales by presenting the right product or service to the proper market target at the appropriate time through the System, enabled by carrying out organized, skillful advertising, often using visual displays and/or linguistic calls-to-action.

Merchant: An online or offline purveyor of goods, products, and/or services.

Network: A connection of two or more processing mechanisms, electronically linked to share and/or exchange resources.

Offer: The default primary project type that is mediated through the System, and manifests design and functional characteristics thematically and dynamically associated with incentives such as demonstrations, samples, coupons, auctions, barter sessions, discounts, trials, demos, freebies, prizes, rewards, points, certificates, samples, bonuses, offers, or other enticing promotional content and/or material.

OfferBook: Special-purpose, user/member-customized catalogs (themed groupings of offers and links to offers). A novel extension to the concept of offline coupon books, OfferBooks contain a user's unique collection of System offers (i.e., interactive coupons, online auctions, etc.), clipped, organized, and summarized for convenient access anytime. Users who become members may be granted options to store their OfferBooks and to create automated agents that clip and store System offers to OfferBooks according to personalized preferences (i.e., date, offer type, location, category, etc.). When users/members click the offer's “CLIP” button to move the offer to their OfferBook, the offer, in some form (e.g., summarized), remains in the OfferBook for time periods specified by users/members, in accord with options granted by administrators.

OfferStudio: An organized presentation of System forms, themes, templates, design elements (e.g., icons, images), previews, wizards designed to assist operators adapt offer text (i.e., truncated offer text introduction with a basic call-to-action), interaction channel(s) (i.e., device-specific response channels), and/or graphics (i.e., images scaled, reformatted, transferred, separated, hidden or deleted) for optimal distribution and display over heterogeneous devices, form factors and access points (i.e., Web sites, interactive presentations, text-only portals/sites, voice portals/sites).

Offer Template (see also, Incentive Template and Template): An online design analogy mapped from offline correlates (e.g., online display formats that resemble offline coupons in appearance) that may have one or more recommended offer types (e.g., an online, enhanced, interactive version of an offline coupon).

Offer Text: Text within an offer that facilitates linguistic calls-to-action or magnifications and clarifications thereof.

Offer Type: An online functional analogy mapped from offline correlates (e.g., an online, enhanced, interactive version of an offline coupon) that may have one or more recommended offer templates (e.g., online display formats that resemble offline coupons in appearance). Offer types may be mapped to a variety of offer templates, which allows for novel and unique combinations of function with form/design (e.g., combining coupon-like functionality with a sweepstakes-like template).

Open Source (also, Open Customization): Referring to software for which some or all of the underlying source code is available to various classes of software developers, licensees, and/or users so that they may read it, make changes to it, and build new or modified versions incorporating their changes. Licensing terms under which altered copies of the source code may or must be redistributed vary.

Operator: A person who is granted a content-level System account with a stored profile, and thus is able to, individually or with a collaborative group or subgroup, perform account administration and incentive merchandising functions related to designing and maintaining the content and features displayed by the System. An operator may be an employee, service or contract agent, practitioner, merchandiser, or marketer associated with the sponsor.

Page Assignment: A slot within an access point reserved to receive System content, delimited by location coordinates.

Page Declaration: An access point address that is entered or imported into the System and approved to receive System content.

Page Declaration Parameter: Descriptive information that accompanies each access point address that is entered or imported into the System, such as: title; type of access point (e.g., page in a Web site, versus page in a voice site, versus card in a wireless deck); geographical and organizational specifiers (e.g., zip code and/or department name); and quantity of coordinates that divide the access point (e.g., dividing a Web page into four sections, each of which may then be processed by the System as distinct units with associated display/distribution caps and limitations).

Page Span Definition: Logical spatial and/or perceptual span that may be assigned within a project type to ensure adequate space for proper presentation and display and/or execution.

Partner: An organization or individual who sublicenses access to the System through the System sponsor, the licensee.

Plan (also, Product/Service/Plan): A logical bundle of System components (e.g., projects and forms combined with specific levels of capability) that is subsequently packaged by administrators for acquisition (i.e., by purchase and/or purchase proxy) by operators. Although operators are the primary audience, users and members may be also be targeted as consumers for products/services/plans (i.e., with limited, delegated capability). For example, a department store's system could be configured with one simple “10K plan” for ads as well as offers. The women's shoe department might be allocated 5 ads and 20 offers per month. Each ad or offer would expire after 10,000 (10K) impressions or at the end of the month, whichever comes first. Administrators can configure the System to support an unlimited number of plans, which may be designed for either partner (external) and/or sponsor (internal) operators. Financial charges may be assigned to plans, (i.e., $10 per 1,000 impressions), and the System supports “productized services” (i.e., combinations of shippable, tangible products with intangible services).

Plan Type (also, Product/Service/Plan Type): A logical framework for associating System-derived benefits with System-mediated benefits (e.g., training combined with projects and space on access points) for consumption by operators.

Peer: A computer or program that receives/processes, sends and, in some cases, relays requests for documents, components, and/or other files over a network to other similarly functioning computers or programs.

Portal (also, System Portal): A point-of-entry to System content, including catalogs in the form of System-mediated directories, maps, and/or search/compare/browse result sets. A System portal may serve as a comprehensive location to serve System content instead of or along with dynamic nodes on external access points. Serving as the centralized destination that aggregates and organizes all System content into searchable categories, the System portal partially or completely hosts all System accounts.

Preview (also, Project Preview): A mock-up that models the way in which a project is likely to appear on a given device or form factor within certain coordinates on an access point under certain content population conditions.

Primary Project Set: The primary grouping used to characterize and organize each project that belongs to it. Projects must be placed in a campaign (i.e., one mandatory primary project set, facilitating granular administrative control), and may be placed in one or more optional (i.e., secondary, matching group discrimination criteria) project set(s)/subset(s), allowing flexible reports, analyses, and alerts.

Primary Project Type: The primary promotional instrument employed by the System, promoted and supported by secondary project types, and organized by tertiary project types.

Profile: Information that distinctly identifies anyone who accesses the System.

Project: A logical promotional enabling instrument designed for online placement, as defined by administrators, manipulated by operators, and consumed by users.

Project Attribute: Characteristic of a project that may be edited by operators and/or administrators, such as relationships with other projects or display position on a Web page. Higher order project attributes, such ad project ID and project type may be restricted to administrative-level edits after initial configuration.

Project Element (see also, Library): Externally-defined or standard objects (e.g., graphics, hypertext, or ASCII text) as well as objects unique to the System (e.g., interaction channels, incentive amounts, forms, and templates) as used in one project or shared across several projects (i.e., sets, subsets). Project elements may be stored in libraries, packaged and rationed through plan types, and tracked for reports/analysis/alerts. Project elements may or may not be shared among and between operators and administrators.

Project ID (see also, Project Attribute): A higher order project attribute that serves as a unique, alphanumeric code for each new offer. Either sequentially generated by the System, automatically generated by the System according to administrator-defined parameters, or delegated to operators, project ID's may be used to track and monitor projects. Each project ID must be unique to a single System project (i.e., no duplicates) and by default may not ever be reused (i.e., ID's permanently retired after project deletion), unless specified at the administrative level. Project ID's may be appended with unique redemption/interaction identifiers and/or encrypted coding to strengthen their usefulness as a fraud protection mechanism.

Project Property: An element of a System-generated profile that is recorded and displayed to assist operators and administrators with tracking projects or groups of projects through time. Properties may be displayed in reports for groups of projects and/or tabs for each project. For instance, each project may manifest a first tab displaying general information, comprising: a project title; titles of forms, themes, and templates drawn upon by the project; the project type; the campaign (i.e., primary project set); and the size (e.g., in kilobytes) of the entire project upon full online display of all project elements. A second tab may display summary information, comprising: creation date, original creator, last date modified, last modifier, and special instructions, comments or notes. A third tab may display workgroup information, comprising: workflow category, the assigned operator, operator group and/or operator subgroup responsible for the project, review status, and publish mode.

Project Set: A grouping used to characterize and organize each project that belongs to it. Using a project set, projects may be filtered, grouped, searched, sorted, and/or summarized by division, department, product, access point, and/or category.

Project Subset: Projects organized within project sets. Thus, for example, projects within a project set may be further filtered, grouped, searched, sorted, and/or summarized by event, geographical region, time zone, page location, and/or category/subcategory.

Project Tool: A special-purpose editor or designer to help operators create projects (e.g., an HTML editor; a graphic designer; or a designer for forms, themes, templates, design elements (e.g., icons, images), previews, and wizards).

Project Type (see also, Project Attribute): A higher order project attribute consisting of a defined set of functional characteristics, exhibiting behaviors often mapped from offline correlates (e.g., an online, enhanced, interactive version of an offline coupon) that may be matched with one or more recommended templates (e.g., online display formats that resemble offline coupons in appearance). Project types may be mapped to a variety of project templates, which allows for novel and unique combinations of function with form/design (e.g., combining coupon-like functionality with a sweepstakes-like template).

Publish Mode (see also, Project Property): An automated or manual project status setting that tracks collaborative work activation and may cascade over project sets and/or project subsets. The range of settings may include, for instance: active versus inactive.

Response Channel (see also, Interaction Channel and OfferStudio): An interaction channel that is adjusted to operate through a low-end device, form factor, or service/carrier by truncating and/or otherwise limiting interactive functionality.

Review Status (see also, Project Property): An automated or manual project status setting that tracks collaborative work review/approval and may cascade over project sets and/or project subsets. The range of settings may include, for instance: approved, denied, pending review, content review, copy review, graphics review, legal review, financial review, manager review, and code review.

Role (see also, Group): Within the context of a System account, an individual, group, or subgroup restricted to certain functional areas, views/perspectives, reports/analysis/alerts and capabilities with respect to collaborative activities.

Secondary Project Type: The secondary promotional instruments employed by the System that promote and support the primary project type and are organized by tertiary project types.

Server: A computer or program that processes requests, most often from clients, for documents, components, and/or other files over a network.

Shop (see also, Interaction Channel): An interface containing functions that filter, group, search, sort, or summarize projects for optimal interactivity (i.e., via interaction channels). Shop serves as the anchor for net (i.e., shop-by-net) and phone (i.e., shop-by-phone) interfaces, which respectively enable project display, input, and output for transacting and/or communicating via the Internet or by telephonic methods.

Sponsor: The organization or individual who owns the System license.

Sponsor-Defined: Refers to System variables or settings which are customarily adjusted by administrators and/or operators, or delegated to sponsor/partner administrators and/or operators, according to the sponsor's business logic.

Syndication (see also, Distribution): An association of sponsors and their partners, each authorized to execute financial transactions, and/or other exchanges, based upon the reciprocal and/or one-way distribution of System content on access point(s) that they control.

System (also, Platform): An Internet (i.e., online) operating system combined with integrated, interactive incentive merchandising and marketing instruments employing implements, such as interfaces, applets, utilities, processes, methodologies, peers, and/or servlets. Collaborative incentive merchandising origination, presentation, organization, management, and distribution functions allow financial transactions, and/or other exchanges, within and between systems.

System-Mediated Functionality (also, Marketable System Functionality): System feature sets that may be rationed by sponsors through their administrators and packaged into System-defined plans (e.g., including projects, project combinations/elements, interaction channels, notices and alerts, reports/analysis/alerts, forms, themes, templates, design elements (e.g., icons, images), previews, wizards, project tools, add-ins, views bar, and operator/member role/group/subgroup configurations).

Template (also, Project Template or Design Template): An online design analogy that is mapped from offline correlates and is capable of manifesting System-mediated functions; similar to an offer template, but also applicable to other project types.

Tertiary Project Type: The tertiary promotional instruments employed by the System that organize the primary project type as well as secondary project types.

Theme (also, Project Theme): A series of forms and/or templates, most often grouped across project types such that there is one of each project type per series, that are thematically associated through the System according to common topical content, aesthetic/design arrangement, and/or functional composition.

Toolbar: A graphical array of menus and/or icons, leading to listings of commands and/or functions.

User (see also, Member): A person who visits, views, accesses and consumes System content, and interacts with features displayed by the System (e.g., members, entrants, visitors, viewers, participants, or anyone with front-end System access).

Wizard (also, Project Wizard): An automated tool, macro, or step-by-step process to guide users and operators through an otherwise lengthy series of System functions.

For instance, the System's internal link wizard employs an internal location pointer to make it easy to link to and promote internal projects without having to write code; external location pointers may also be included to facilitate use of frequently used URL's and destination addresses outside of the System.

Workflow Category (see also, Project Property): An automated or manual project status setting that tracks the collaborative work process and may cascade over project sets and/or project subsets. The range of settings may include, for instance: normal, critical, to schedule, in process, on hold, revising, planning, and ideas.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method for managing online offers in a networked environment, comprising the steps of:
(a) using an offer management tool to establish rules relating to at least one online offer, said rules defining for said at least one offer, at least one of:
(i) a term;
(ii) a subject;
(iii) a location; and
(iv) a duration;
(b) employing the offer management tool to generate online offer content for said at least one online offer, without requiring programming knowledge by an operator of the offer management tool;
(c) using the offer management tool to enable a determination of whether the online offer content conforms to the rules; and if so,
(d) using the offer management tool to post the at least one online offer to the networked environment in accord with the rules, to make said at least one offer available for access by others.

2. The method of claim 1, wherein said at least one online offer comprises an offer for a sale of goods.

3. The method of claim 1, wherein said at least one online offer comprises a redeemable coupon.

4. The method of claim 1, wherein said at least one online offer comprises a rebate.

5. The method of claim 1, wherein said at least one online offer comprises a contest.

6. The method of claim 1, wherein said at least one online offer comprises an incentive designed to induce a person accessing said at least one offer, to a specific call-to-action.

7. The method of claim 1, wherein said at least one online offer comprises an incentive designed to induce a person accessing said at least one offer, to a specific call-to-purchase.

8. The method of claim 1, wherein the rules further comprise parameters defining said at least one online offer, said parameters including at least one of:
(a) a time period for which said at least one online offer is to be available for access;
(b) a target audience to which said at least one online offer is to be directed;
(c) an online location to which said at least one online offer is to be posted;
(d) a specific good to which said at least one online offer is directed;
(e) a specific service to which said at least one online offer is directed;
(f) a dollar value associated with said at least one online offer;
(g) a percentage associated with said at least one online offer; and
(h) a size with which said at least one online offer is to be displayed.

9. The method of claim 1, wherein an administrator employs the offer management tool to define the rules.

10. The method of claim 9, wherein an operator, who is authorized by the administrator, uses the offer management tool to generate the content for said at least one online offer.

11. The method of claim 10, wherein the administrator and the operator are employed by different entities.

12. The method of claim 10, wherein the administrator is a retailer and the operator is a manufacturer of goods associated with said at least one online offer.

13. The method of claim 10, wherein the administrator is a retailer and the operator is a reseller of goods associated with said at least one online offer.

14. The method of claim 1, wherein the offer management tool employs a plurality of hierarchical security levels to determine functions performed by a person who is using it, based on rights associated with a security level of said person.

15. The method of claim 1, wherein the step of enabling the offer management tool to determine if the online offer content conforms to the rules comprises the step of enabling the offer management tool to automatically distribute said at least one online offer to specific individuals whose approval is required before said at least one online offer is posted to the networked environment.

16. The method of claim 1, wherein the step of posting said at least one online offer to the networked environment comprises the step of the offer management tool inserting said at least one online offer into a dynamic node disposed at an online location to which said at least one online offer is to be posted.

17. The method of claim 1, wherein the rules are established at a central location, and the content is generated at a plurality of geographically disparate locations.

18. The method of claim 1, further comprising the step of using the offer management tool to insert a plurality of dynamic nodes throughout the networked environment.

19. The method of claim 1, further comprising the step of enabling the offer management tool to track activity by others who are accessing said at least one online that has been posted.

20. The method of claim 19, wherein the activity that is tracked comprises at least one of hits, redemptions, purchases, and requests for information.

21. The method of claim 1, further comprising the step of authorizing at least one operator to use the offer management tool in regard to said at least one online offer.

22. The method of claim 21, wherein the step of employing the offer management tool to generate online offer content comprises the steps of:
(a) enabling each authorized operator to use the offer management tool to define each access point in the networked environment where an online offer is to be displayed;
(b) enabling each authorized operator to use the offer management tool to determine if a dynamic node exists at any access point that was defined;
(c) enabling each authorized operator to use the offer management tool to insert a dynamic node at any access point that was defined, if no dynamic node exists there; and
(d) enabling each authorized operator to use the offer management tool to define activation and deactivation parameters that control a display of said at least one online offer at any access point that was defined.

23. The method of claim 22, wherein the activation and deactivation parameters comprise at least one of:
(a) alternating a display of a plurality of different online offers at an access point according to a defined schedule;
(b) displaying an online offer at the defined location according to a profile of a person accessing the access point;
(c) displaying an online offer at the defined location until a predefined number of hits has been achieved; and
(d) displaying an online offer at the defined location according to a predefined schedule.

24. The method of claim 23, wherein the activation and deactivation parameters comprise minimizing a size of a dynamic node at the predefined location when no online offer is to be displayed, such that an empty frame is not perceptible to a person accessing the access point in the networked environment.

25. An article of manufacture adapted for use with a processor, comprising:
(a) a memory medium; and
(b) a plurality of machine instructions, which are stored on the memory medium, said plurality of machine instructions when executed by a processor, causing the processor to:
(i) enable a user to at establish rules relating to at least one online offer, said rules defining for said at least one offer, at least one of a term of the offer, a subject of the offer, a location of the offer and a duration of the offer;
(ii) enable a user to generate online offer content for said at least one online offer, without requiring programming knowledge;
(iii) determine if the online offer content is consistent with the rules established for the at least one online offer; and
(v) post the at least one online offer to the networked environment in accord with the rules, to make said at least one offer available for access by others.

26. The article of manufacture of claim 25, wherein the plurality of machine instructions, when executed by a processor, further cause the processor to employ a plurality of hierarchical security levels to determine functions performed by a person who is using it, based on rights associated with a security level of said person.

27. The article of manufacture of claim 25, wherein the plurality of machine instructions, when executed by a processor, further cause the processor to enable a plurality of dynamic nodes to be inserted throughout the networked environment.

28. The article of manufacture of claim 25, wherein the plurality of machine instructions, when executed by a processor, further cause the processor:
(a) enable each authorized operator to define each access point in the networked environment where an online offer is to be displayed;
(b) determine if a dynamic node exists at the defined location;
(c) insert a dynamic node at any access point that was defined, if no dynamic node exists there; and
(d) enabling each authorized operator to define activation and deactivation parameters that control a display of said at least one online offer at any access point that was defined.

29. A system for managing online offers available to others in a networked environment, comprising:
(a) a memory in which a plurality of machine instructions are stored;
(b) a display; and
(c) a processor that is coupled to the display and to the memory to access the machine instructions, said processor executing said machine instructions to implement a plurality of functions, including:
(i) enabling a user to at establish rules relating to at least one online offer, said rules defining for said at least one offer, at least one of a term of the offer, a subject of the offer, a location of the offer and a duration of the offer;
(ii) enabling a user to generate online offer content for said at least one online offer, without requiring programming knowledge;
(iii) determining if the online offer content is consistent with the rules established for the at least one online offer; and
(v) posting the at least one online offer to the networked environment in accord with the rules, to make said at least one offer available for access by others.

30. The system of claim 29, wherein the machine instructions, when executed by a processor, further implement a plurality of functions, as follows:
(a) enabling each authorized operator to define each access point in the networked environment where an online offer is to be displayed;
(b) determining if a dynamic node exists at any access point that was defined;
(c) inserting a dynamic node at any access point that was defined, if no dynamic node exists there; and
(d) enabling each authorized operator to define activation and deactivation parameters that control a display of said at least one online offer at any access point that was defined.

31. The system of claim 29, wherein the machine instructions, when executed by a processor, further implement the function of employing a plurality of hierarchical security levels to determine functions performed by a person who is using it, based on rights associated with a security level of said person.

32. A method for introducing an online offer into a networked environment, for access by others, comprising the steps of:
(a) determining a specific location in the networked environment where the online offer is to be accessible by others;
(b) using an offer management tool to generate the online offer;
(c) inserting a dynamic node at the specific location, such that the dynamic node is linked to the online offer through the offer management tool;
(d) using the offer management tool to define activation and deactivation parameters that control access of the online offer at the specific location; and
(e) using the offer management tool for introducing the online offer at the specific location and making it accessible by others, according to the defined activation and deactivation parameters.

33. The method of claim 32, further comprising the step of using the offer management tool to track activity relating to access of the online offer by others.

34. The method of claim 32, wherein the activity tracked comprises at least one of hits, redemptions, purchases, and requests for information.

35. The method of claim 32 wherein the online offer comprises at least one of an offer for a sale of goods, a redeemable coupon, a rebate, a contest, an incentive designed to induce a person to carry out a specific call-to-action, and an incentive designed to induce a person to carry out a specific call-to-purchase.

36. The method of claim 32, further comprising the step of using the offer management tool to control access to the dynamic node for purposes of effecting the online offer linked to the dynamic node, such that only authorized operators are able to modify the online offer linked to the dynamic node, while all other persons are only able to access the online offer linked to the dynamic node, but without modifying the online offer.

37. The method of claim 36, wherein the step of using the offer management tool to control access to the online offer using the offer management tool comprises the steps of:
(a) enabling an administrator to authorize at least one operator to access the offer management tool for use with the online offer; and
(b) enabling each operator authorized to access the online offer to use the offer management tool to generate content for the online offer.

38. The method of claim 37, further comprising the step of enabling the administrator to establish rules relating to the online offer.

39. The method of claim 38, further comprising the step of determining if the content is consistent with the rules established by the administrator.

40. The method of claim 38, wherein the rules comprise parameters defining the online offer, said parameters including at least one of:
(a) a duration for which the online offer is to be accessible by others online;
(b) a target audience to which the online offer is directed;
(c) the specific online location to which the online offer is to be posted;
(d) a specific good to which the online offer is directed;
(e) a specific service to which the online offer is directed;
(f) a dollar value associated with the online offer;
(g) a percentage associated with the online offer; and
(h) a size with which the online offer is to be displayed.

41. The method of claim 32, further comprising the step of linking the dynamic node to a shopping cart purchasing function associated with the specific location, such that someone accessing the online offer and desiring to make a purchase related to the online offer is linked to the shopping cart purchasing function to consummate the purchase.

42. The method of claim 32, further comprising the step of linking the dynamic node to an inventory system associated with the specific location, such that when a purchase of a quantity of an item related to the online offer is made, the quantity of the item purchased is deducted from an inventory of the item by the inventory system.

43. An article of manufacture adapted for use with a processor, comprising:
(a) a memory medium; and
(b) a plurality of machine instructions, which are stored on the memory medium, said plurality of machine instructions when executed by a processor, causing the processor to:
(i) enable a specific location in the networked environment where an online offer is to be accessible by others to be identified;
(ii) enable a user to generate the online offer content using an offer management tool;
(iii) enable a dynamic node to be inserted at the specific location, such that the dynamic node is linked to the offer management tool;
(iv) enable activation and deactivation parameters that control access of the online offer at the specific location to be defined; and
(v) introduce the online offer at the specific location and making it accessible by others, according to the defined activation and deactivation parameters.

44. The article of manufacture of claim 43, wherein the plurality of machine instructions, when executed by a processor, further causing the processor to track activity relating to the online offer using the offer management tool, wherein the activity tracked comprises at least one of hits, redemptions, purchases, and requests for information.

45. The article of manufacture of claim 43, wherein the plurality of machine instructions, when executed by a processor, further causing the processor to enable access to the online offer to be controlled, such that only authorized operators are able to modify the online offer linked to the dynamic node, while all other persons are only able to access the online offer linked to the dynamic node, but without modifying the online offer.

46. A system for managing online merchandising offers available to users in a networked environment, comprising:
(a) a memory in which a plurality of machine instructions defining the parent application are stored;
(b) a display; and
(c) a processor that is coupled to the memory to access the machine instructions and to the display, said processor executing said machine instructions which thereby cause the processor to:
(i) enable a specific location in the networked environment where an online offer is to be accessible by others to be identified;
(ii) enable a user to generate the online offer content using an offer management tool;
(iii) enable a dynamic node to be inserted at the specific location, such that the dynamic node is linked to the offer management tool;
(iv) enable activation and deactivation parameters that control access of the online offer at the specific location to be defined; and
(v) introduce the online offer at the specific location and making it accessible by others, according to the defined activation and deactivation parameters.

47. The system of claim 46, wherein the plurality of machine instructions, when executed by a processor, further cause the processor to enable access to the online offer to be controlled, such that only authorized operators are able to modify the online offer linked to the dynamic node, while all other persons are only able to access the online offer linked to the dynamic node, but without modifying the online offer.

48. A method for enabling access points accessed over a network to include online offers that are dynamically managed by an offer management tool, comprising the steps of:
(a) identifying each specific access point where an online offer is to be made accessible to others over the network;
(b) for each specific access point that is identified, inserting a dynamic node at the specific access point, said dynamic node being dynamically linkable with an online offer using the offer management tool; and
(c) linking specific online offers to selected corresponding specific dynamic nodes with the offer management tool, so that the online offers can be accessed by others over the network.

49. The method of claim 48, further comprising the step of integrating each dynamic node with an inventory system associated with the access point, thereby enabling data maintained by the inventory system to be updated if acceptance by a person of the online offer affects the data maintained by the inventory system.

50. The method of claim 48, further comprising the step of defining a content for the online offer linked to a dynamic node, so that the content matches a style associated with specific access point at which the dynamic node is inserted.

51. The method of claim 48, further comprising the step of configuring each dynamic node so that when no online offer is selectively linked to that dynamic node, the dynamic node is substantially imperceptible.

52. The method of claim 48, wherein only authorized individuals are able to use the offer management tool to make changes to content of any online offer linked to a dynamic node.

53. An article of manufacture adapted for use with a processor, comprising:
(a) a memory medium; and
(b) a plurality of machine instructions, which are stored on the memory medium, said plurality of machine instructions when executed by a processor, causing the processor to:
(i) enable each specific access point where an online offer is to be made accessible to others over a network to be identified;
(ii) for each specific access point that is identified, enable a dynamic node to be inserted at the specific access point, said dynamic node being dynamically linkable with an online offer using an offer management tool; and
(iii) link specific online offers to selected corresponding specific dynamic nodes with the offer management tool, so that the online offers can be accessed by others over the network.

54. The article of manufacture of claim 53, wherein the plurality of machine instructions, when executed by a processor, further causing the processor to enable each dynamic node to be configured so that when no online offer is displayed by a dynamic node, that dynamic node is substantially imperceptible.

55. The article of manufacture of claim 53, wherein the plurality of machine instructions, when executed by a processor, further causing the processor to enable only authorized individuals to make changes to content of any online offer linked to a dynamic node.

56. A system for enabling online merchandising offers managed by a dynamic offer management tool to be incorporated into a Web site, comprising:
(a) a memory in which a plurality of machine instructions defining the parent application are stored;
(b) a display; and
(c) a processor that is coupled to the memory to access the machine instructions and to the display, said processor executing said machine instructions and thereby implementing a plurality of functions, as follows:
(i) enabling each specific access point where an online offer is to be made accessible to others over the network to be identified;
(ii) for each specific access point that is identified, inserting a dynamic node at the specific access point, said dynamic node being dynamically linkable with an online offer using the offer management tool; and
(iii) linking specific online offers to selected corresponding specific dynamic nodes with the offer management tool, so that the online offers can be accessed by others over the network.

57. The system of claim 56, wherein the machine instructions, when executed by a processor, enable only authorized individuals to make changes to content of any online offer linked to a dynamic node.

58. A method for enabling an authorized person to introduce an online offer at a specific location in a networked environment, comprising the steps of:
(a) selecting an online offer to be accessed by others over the networked environment;
(b) determining the specific location in the networked environment where the online offer that was selected is to be introduced;
(c) determining if a dynamic node exists at the specific location, said dynamic node being linkable to the online offer through an offer management tool, and if not, generating said dynamic node at the specific location;
(d) determining if an existing online offer is linked to the dynamic node at the specific location, and if so, performing one of the following steps:
(i) determining if the existing online offer is to be deactivated; and
(ii) determining if access to the existing online offer is to alternate with access to the online offer that was selected, according to defined parameters;
(e) determining if the online offer that was selected will fit at the specific location, and if not, configuring the online offer that was selected to fit at the specific location with the offer management tool;
(f) using the offer management tool to define activation and deactivation parameters that will control access by others of the online offer that was selected, when inserted at the specific location; and
(e) linking the online offer that was selected to the dynamic node at the specific location, such that said online offer will be accessible by others according to the defined activation and deactivation parameters.

59. The method of claim 58, further comprising the step of transmitting online offer that was selected to a specific individual for approval prior to linking said online offer to the dynamic node at the specific location.

60. The method of claim 58, further comprising the step of linking the dynamic node to a shopping cart purchasing function associated with the specific location, such that someone making a purchase of an item in response to the online offer is linked to the shopping cart purchasing function, to consummate the purchase.

61. The method of claim 58, further comprising the step of linking the dynamic node to an inventory system associated with the specific location, such that changes are automatically made to inventory data maintained by the inventory system, as a result of a person interacting with the online offer.

62. An article of manufacture adapted for use with a processor, comprising:
(a) a memory medium; and
(b) a plurality of machine instructions, which are stored on the memory medium, said plurality of machine instructions when executed by a processor, cause the processor to:
(i) enable an online offer to be accessed by others over the networked environment to be selected;
(ii) enable the specific location in the networked environment where the online offer that was selected is to be introduced to be determined;
(iii) determine if a dynamic node exists at the specific location, said dynamic node being linkable to the online offer that was selected, and if not, generating said dynamic node at the specific location;
(iv) determine if an existing online offer is being displayed by the dynamic node at the specific location, and if so, determining if access to the existing online offer is to be deactivated; or if access to the existing online offer is to alternated with access to online offer that was selected, such alternating access being controlled according to a defined parameter;
(v) determine if the online offer that was selected will fit at the specific location, and if not, configuring the online offer that was selected to fit at the specific location;
(vi) enable activation and deactivation parameters to be defined, said activation and deactivation parameters controlling access by others of the online offer that was selected at the specific location; and
(vi) link the online offer that was selected to the dynamic node at the specific location, such that said online offer will be accessible by others according to the defined activation and deactivation parameters.

63. A system for enabling an authorized user to include an online offer at a specific location in a networked environment, comprising:
(a) a memory in which a plurality of machine instructions defining the parent application are stored;
(b) a display; and
(c) a processor that is coupled to the memory to access the machine instructions and to the display, said processor executing said machine instructions and thereby implementing a plurality of functions, as follows:
(i) enabling an online offer to be accessed by others over the networked environment to be selected;
(ii) enabling the specific location in the networked environment where the online offer that was selected is to be introduced to be determined;
(iii) determining if a dynamic node exists at the specific location, said dynamic node being linkable to the online offer that was selected, and if not, generating said dynamic node at the specific location;
(iv) determining if an existing online offer is being displayed by the dynamic node at the specific location, and if so, determining if access to the existing online offer is to be deactivated; or if access to the existing online offer is to alternated with access to online offer that was selected, such alternating access being controlled according to a defined parameter;
(v) determining if the online offer that was selected will fit at the specific location, and if not, configuring the online offer that was selected to fit at the specific location;
(vi) enabling activation and deactivation parameters to be defined, said activation and deactivation parameters controlling access by others of the online offer that was selected at the specific location; and
(vi) linking the online offer that was selected to the dynamic node at the specific location, such that said online offer will be accessible by others according to the defined activation and deactivation parameters.

64. A method managing a plurality of online offers using an integrated offer management tool, comprising the steps of:
(a) inserting a plurality of dynamic nodes into an online network, such that each dynamic node is inserted into a specific network location defined by the offer management tool;
(b) making online offer content available to the offer management tool; and
(c) using the offer management tool to control the display of the online offer content at any of the dynamic nodes inserted into the network.

65. The method of claim 64, wherein the step of inserting a plurality of dynamic nodes into an online network comprises the step of inserting code to each network location defined by the offer management tool that links each dynamic node to the offer management tool.

66. The method of claim 64, wherein the step of inserting a plurality of dynamic nodes into an online network comprises the step of inserting code to each network location defined by the offer management tool corresponding to a specific dynamic node that defines a coordinate position of that specific dynamic node.
